(19) United States
(12) Patent Application Publication
(10) Pub. No.: US 2025/0362510 A1
(43) Pub. Date: Nov. 27, 2025

(54) OPTICAL SYSTEM, DISPLAY DEVICE, AND IMAGING DEVICE

(71) Applicant: Panasonic Intellectual Property Management Co., Ltd., Osaka (JP)

(72) Inventors: Satoshi Kuzuhara, Osaka (JP); Tsuneo Uchida, Chiba (JP)

(21) Appl. No.: 19/288,368

(22) Filed: Aug. 1, 2025

Related U.S. Application Data
(63) Continuation of application No. PCT/JP2023/046412, filed on Dec. 25, 2023.

(30) Foreign Application Priority Data
Feb. 3, 2023 (JP) 2023-015576

(51) Int. Cl. G02B 27/01; G02B 27/09

(52) U.S. Cl. CPC G02B 27/0172; G02B 27/0972; G02B 2027/013; G02B 2027/0136; G02B 2027/0138

(57) ABSTRACT

An optical system includes first and second optical systems constituted by a prism, define optical paths by different light beam groups and including: reducing side transmissive surfaces facing a reducing side conjugate point; magnifying side transmissive surfaces of the prism, farthest from the reducing side conjugate point along the optical paths; and reflective surface groups which reflect inside the prism the light beam groups with transmission of the reducing side transmissive surfaces and the magnifying side transmissive surfaces to make the reducing side conjugate point and magnifying side conjugate points be in a conjugate relation, and include reflective surfaces with a concave shape, respectively. Within the reflective surface groups, reducing side reflective surfaces closest to the reducing side conjugate point along the optical paths are on opposite sides with regard to a straight line passing through a midpoint between the reducing side transmissive surfaces and the reducing side conjugate point.

### CROSS-REFERENCE TO RELATED APPLICATIONS

The present application is a continuation of PCT/JP2023/046412 filed Dec. 25, 2023, which claims priority to Japanese Patent Application No. 2023-015576, filed on Feb. 3, 2023, the entire contents of which are incorporated herein by reference.

### TECHNICAL FIELD

The present disclosure relates to optical systems, display devices, and imaging devices.

### BACKGROUND ART

Patent literature 1 discloses an HMD (head-mounted display) device. The HMD device disclosed in patent literature 1 includes a camera, a combiner optic and a processor for the purpose of detecting and correcting binocular misalignment. The combiner optic has a 45-degree angled internal surface at its left end, which reflects a partial left image 90 degrees to the right. The combiner optic includes an internal optical combining interface at its right end. This is a 50-50 beam splitter with a reflective coating on one surface. The internal optical combining interface allows a partial right image to propagate to the camera and reflects the partial left image 90 degrees to be incident on the camera.

### CITATION LIST

### Patent Literature

PATENT LITERATURE: U.S. Ser. No. 10/425,636 B2

### SUMMARY OF INVENTION

### Technical Problem

The HMD device disclosed in patent literature 1 uses the combiner optic to allow partial left and right images to be incident on the camera. However, the combiner optic employs the 50 to 50 beam splitters (half mirrors) and therefore total light amount of light beam groups of the partial left and right images incident on the camera light is equal to or smaller than a half of that incident on the combiner optic.

The present disclosure provides optical systems, display devices and imaging devices which enable reducing loss of light beam groups.

### Solution to Problem

An optical system according to one aspect of the present disclosure includes a first optical system and a second optical system which are constituted by a prism. The first optical system defines a first optical path by a first light beam group and includes a first reducing side transmissive surface facing a reducing side conjugate point, a first magnifying side transmissive surface which is part of the prism and is located farthest from the reducing side conjugate point along the first optical path, and a first reflective surface group which reflects inside the prism the first light beam group with transmission of the first reducing side transmissive surface and the first magnifying side transmissive surface to make the reducing side conjugate point and a first magnifying side conjugate point be in a conjugate relation, and includes at least a first reflective surface with a concave shape. The second optical system defines a second optical path by a second light beam group different from the first light beam group and includes a second reducing side transmissive surface facing the reducing side conjugate point, a second magnifying side transmissive surface which is part of the prism and is located farthest from the reducing side conjugate point along the second optical path, and a second reflective surface group which reflects inside the prism the second light beam group with transmission of the second reducing side transmissive surface and the second magnifying side transmissive surface to make the reducing side conjugate point and a second magnifying side conjugate point be in a conjugate relation, and includes at least a second reflective surface with a concave shape. The first reflective surface group includes a first reducing side reflective surface which is located closest to the reducing side conjugate point along the first optical path. The second reflective surface group includes a second reducing side reflective surface which is located closest to the reducing side conjugate point along the second optical path. The first reducing side reflective surface and the second reducing side reflective surface are located on opposite sides with regard to a straight line passing through a midpoint between the first reducing side transmissive surface and the second reducing side transmissive surface, as well as the reducing side conjugate point.

A display device according to one aspect of the present disclosure includes the aforementioned optical system; and a display unit including a display element located at the reducing side conjugate point. The display element is configured to output a first light beam group forming a first image toward the first reducing side transmissive surface and output a second light beam group forming a second image toward the second reducing side transmissive surface. The first optical system forms the first image by the first light beam group at the first magnifying side conjugate point. The second optical system forms the second image by the second light beam group at the second magnifying side conjugate point.

An imaging device according to one aspect of the present disclosure includes the aforementioned optical system; and an imaging element located at the reducing side conjugate point. The optical system is located to allow a first light beam group forming a first image to be incident on the first magnifying side transmissive surface from the first magnifying side conjugate point, and to allow a second light beam group forming a second image to be incident on the second magnifying side transmissive surface from the second magnifying side conjugate point. The first optical system forms the first image by the first light beam group at the imaging element. The second optical system forms the second image by the second light beam group at the imaging element.

### Advantageous Effects of Invention

Aspects of the present disclosure enables reduction of loss of light beam groups.

### BRIEF DESCRIPTION OF DRAWINGS

FIG. 1 is a schematic view of a configuration example of a display device according to embodiment 1.

FIG. 2 is a schematic view of a configuration example of a display unit of the display device according to embodiment 1.

FIG. 3 is a schematic view of a configuration example of an optical system of the display device according to embodiment 1.

FIG. 4 is an explanatory view of an optical path of the optical system according to embodiment 1, viewed in a +Y direction.

FIG. 5 is an explanatory view of optical paths of a first optical system and a second optical system of the optical system according to embodiment 1.

FIG. 6 is an explanatory view of the optical path of the optical system according to embodiment 1, viewed in a −X direction.

FIG. 7 is a schematic view of a configuration example of a display device according to embodiment 2.

FIG. 8 is a schematic view of a configuration example of a display device according to embodiment 3.

FIG. 9 is a schematic view of a configuration example of an image projection device according to embodiment 4.

FIG. 10 is a schematic view of a configuration example of an imaging device of the image projection device according to embodiment 4.

FIG. 11 is a schematic view of a configuration example of an optical system according to embodiment 5.

FIG. 12 is a schematic view of a configuration example of an optical system according to embodiment 6.

FIG. 13 is a schematic view of a configuration example of an optical system according to embodiment 7.

### DESCRIPTION OF EMBODIMENTS

### 1. Embodiments

Hereinafter, embodiments of the present disclosure will be described with reference to the drawings where appropriate. However, the following embodiments are merely examples for explaining the present disclosure, and are not intended to limit the present disclosure to the following content (e.g., shapes, dimensions, arrangement and the like, of components). Positional relations such as up, down, left, and right are based on the positional relations shown in the drawings, unless otherwise specified. Each figure described in the following embodiments is a schematic diagram, and the ratios of size and thickness of each component in each figure do not necessarily reflect the actual dimensional ratios. Furthermore, the dimensional ratios of each element are not limited to the ratios shown in the drawings.

In the following description, if it is necessary to distinguish a plurality of components from each other, prefixes, such as, “first”, “second”, or the like are attached to names of such components. However, if these components can be distinguished from each other by reference signs attached to those components, such prefixes, such as, “first”, “second”, or the like, may be omitted in consideration of readability of texts.

In the present disclosure, expressions “travel in_direction” and “propagate in_direction” used in relation to light rays mean that a light ray forming an image travels in the_direction as a whole and therefore light beams included in the light ray forming the image may be permitted to be inclined relative to the_direction. For example, regarding a “light ray traveling in_direction”, it is sufficient that a main light beam of this light is directed in the_direction, and auxiliary beams of this light may be inclined relative to the_direction.

In the present disclosure, the term “diffraction structure” may also mean “periodic structure” having a plurality of recessed parts or protruded parts arranged periodically. Note that, in some cases, depending on restriction on manufacture or other situations, the “diffraction structure” may include, in addition to the “periodic structure” an incomplete periodic structure.

### 1.1 Embodiment 1

### 1.1.1 Configurations

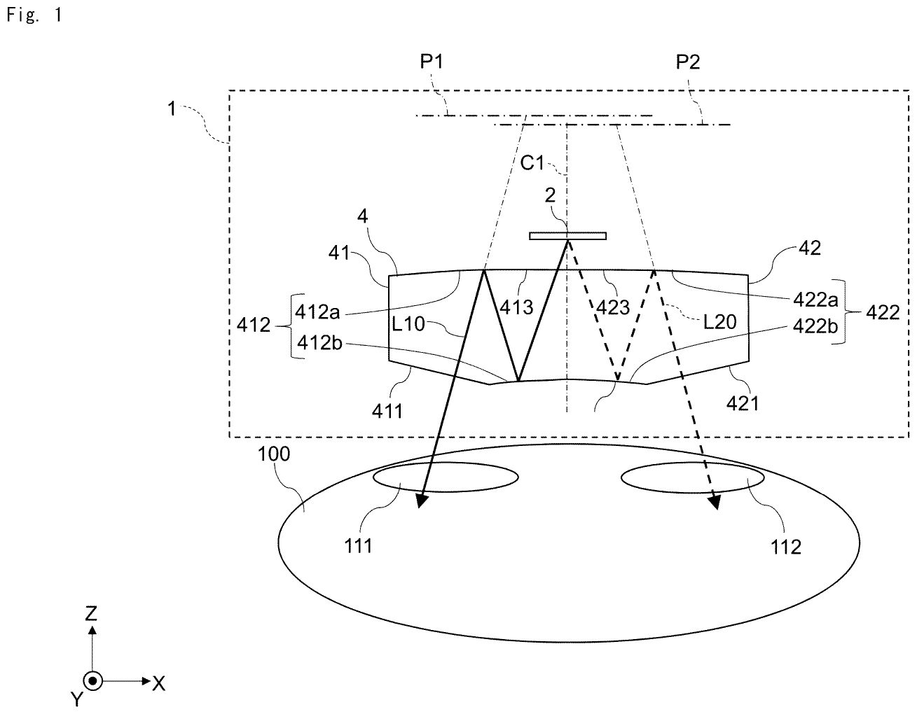

FIG. 1 is a schematic view of a configuration example of a display device 1 according to the present embodiment. The display device 1 projects images on a first eye 111 and a second eye 112 of an observer 100. The first eye 111 is the left eye and the second eye 112 is the right eye.

The display device 1 includes a display unit 2 and an optical system 4.

The display unit 2 includes a display element 21 configured to output a first light beam group L10 forming a first image P1 to be projected on the first eye 111 of the observer 100. The display element 21 is configured to output a second light beam group L20 forming a second image P2 to be projected on the second eye 112 of the observer 100. In FIG. 1, only for simplification, the first light beam group L10 and the second light beam group L20 each are depicted as a single arrow, but in fact may be a light ray with an angle corresponding to a field of view angle.

The first image P1 and the second image P2 may be set appropriately in accordance with the purpose or the like, of the display device 1. For example, as the first image P1 and the second image P2, images for augmented reality, virtual reality, or mixed reality may be used. In the present embodiment, the first image P1 and the second image P2 are different from each other. As one example, the first image P1 and the second image P2 may be images superimposed or overlaid on the real world (real space). The first image P1 and the second image P2 are set to artificially induce binocular disparity in the observer 100.

The display element 21 is configured to output the first light beam group L10 and the second light beam group L20 in different directions. In the present embodiment, the display element 21 is located at a reducing side conjugate point F1 of the optical system 4. The display element 21 outputs the first light beam group L10 toward the first reducing side transmissive surface 413 of the optical system 4, and outputs the second light beam group L20 toward a second reducing side transmissive surface 423 of the optical system 4. The reducing side conjugate point F1, the first reducing side transmissive surface 413, and the second reducing side transmissive surface 423 will be described below.

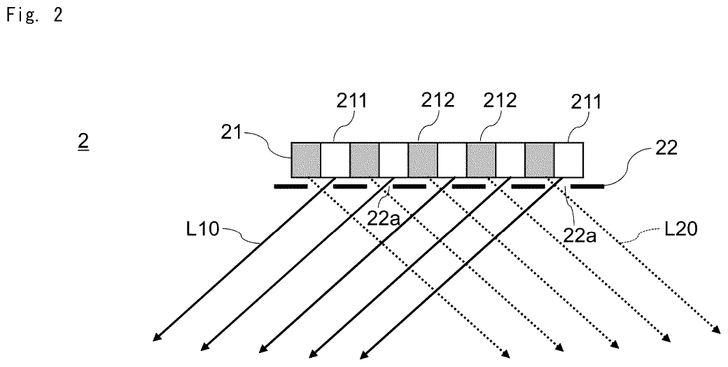

FIG. 2 is a schematic view of a configuration example of the display unit 2. The display unit 2 includes the display element 21 and a parallax barrier 22.

The display element 21 is configured to output the first light beam group L10 and the second light beam group L20 simultaneously. The display element 21 includes first pixels 211 and second pixels 212 arranged alternately. The first pixels 211 output the first light beam group L10, and the second pixels 212 output the second light beam group L20. In FIG. 2, only for better understanding, the second pixels 212 are painted gray. Examples of the display element 21 may include known displays such as, a liquid crystal display, an organic EL display, a scanning MEMS mirror, LCOS (Liquid Crystal On Silicon), DMD (Digital Mirror Device), micro-LED, and SLM (Spatial Light Modulator).

The parallax barrier 22 is located between the display element 21 and the optical system 4. In another expression, the parallax barrier 22 is located on a magnifying side of the display element 21. The parallax barrier 22 includes a plurality of slits 22a. The plurality of slits 22a are arranged to allow passage of the first light beam group L10 in only a first direction, and to allows passage of the second light beam group L20 in only a second direction different from the first direction. The first direction is a direction from the display element 21 toward the first reducing side transmissive surface 413. The second direction is a direction from the display element 21 toward the second reducing side transmissive surface 423.

As described above, the display element 21 outputs the first light beam group L10 and the second light beam group L20 simultaneously. The display unit 2 includes the parallax barrier 22 located between the display element 21 and the optical system 4. The parallax barrier 22 allows only the first light beam group L10 from the first light beam group L10 and the second light beam group L20 to be incident on the first reducing side transmissive surface 413, and allows only the second light beam group L20 from the first light beam group L10 and the second light beam group L20 to be incident on the second reducing side transmissive surface 423. This configuration enables display of different images by the single display element 21. This allows providing the first image P1 and the second image P2 corresponding to a parallax viewed from the first eye 111 and the second eye 112, to the observer 100.

The optical system 4 is used to guide the first light beam group L10 forming the first image P1 and the second light beam group L20 forming the second image P2 from the display element 21 to the first eye 111 and the second eye 112 of the observer 100, respectively. The optical system 4 includes a first optical system 41 and a second optical system 42. The first optical system 41 and the second optical system 42 are constituted by a prism 40. The prism 40 may be a prism formed by a single part or may be a prism formed by combining multiple parts. Note that, the first optical system 41 and the second optical system 42 may be constituted by, in addition to the prism 40, other components such as one or more lenses or one or more mirrors.

The first optical system 41 defines first magnifying side conjugate points F21, F21a outside the prism 40 for the reducing side conjugate point F1 outside the prism 40. The first magnifying side conjugate point F21 is a conjugate point corresponding to a real image and the first magnifying side conjugate point F21a is a conjugate point corresponding to a virtual image. The present embodiment is directed to real images and thus the first magnifying side conjugate point F21 will be described. The first optical system 41 defines a first optical path L1 between the reducing side conjugate point F1 and the first magnifying side conjugate point F21. In the present embodiment, the first magnifying side conjugate point F21 is located at infinity, but only for simplification, it is depicted as an arbitrary point. Note that, the first magnifying side conjugate point F21 may not be located at infinity but may be adjusted to be located at a finite distance in accordance with visual acuity of the observer 100.

The reducing side conjugate point F1 and the first magnifying side conjugate point F21 are in a conjugate relation. In other words, if the reducing side conjugate point F1 is an object point, the first magnifying side conjugate point F21 is an image point, and if the reducing side conjugate point F1 is an image point, the first magnifying side conjugate point F21 is an object point. The reducing side conjugate point F1 and the first magnifying side conjugate point F21 are in a relation causing magnification from the reducing side conjugate point F1 to the first magnifying side conjugate point F21 and reduction from the first magnifying side conjugate point F21 to the reducing side conjugate point F1. In other words, an object at the reducing side conjugate point F1 is smaller than an image of the object at the first magnifying side conjugate point F21, and an object at the first magnifying side conjugate point F21 is larger than an image of the object at the reducing side conjugate point F1.

The second optical system 42 defines second magnifying side conjugate points F22, F22a outside the prism 40 for the reducing side conjugate point F1 outside the prism 40. The second magnifying side conjugate point F22 is a conjugate point corresponding to a real image and the second magnifying side conjugate point F22a is a conjugate point corresponding to a virtual image. The present embodiment is directed to real images and thus the second magnifying side conjugate point F22 will be described. The second magnifying side conjugate point F22 is different from the first magnifying side conjugate point F21. The second optical system 42 defines a second optical path L2 between the reducing side conjugate point F1 and the second magnifying side conjugate point F22. In the present embodiment, the second magnifying side conjugate point F22 is located at infinity, but only for simplification, it is depicted as an arbitrary point. Note that, the second magnifying side conjugate point F22 may not be located at infinity but may be adjusted to be located at a finite distance in accordance with visual acuity of the observer 100.

The reducing side conjugate point F1 and the second magnifying side conjugate point F22 are in a conjugate relation. In other words, if the reducing side conjugate point F1 is an object point, the second magnifying side conjugate point F22 is an image point, and if the reducing side conjugate point F1 is an image point, the second magnifying side conjugate point F22 is an object point. The reducing side conjugate point F1 and the second magnifying side conjugate point F22 are in a relation causing magnification from the reducing side conjugate point F1 to the second magnifying side conjugate point F22 and reduction from the second magnifying side conjugate point F22 to the reducing side conjugate point F1. In other words, an object at the reducing side conjugate point F1 is smaller than an image of the object at the second magnifying side conjugate point F22, and an object at the second magnifying side conjugate point F22 is larger than an image of the object at the reducing side conjugate point F1.

In the present embodiment, the display element 21 is located at the reducing side conjugate point F1 of the optical system 4. The display element 21 outputs the first light beam group L10 forming the first image P1 to the first reducing side transmissive surface 413, and outputs the second light beam group L20 forming the second image P2 to the second reducing side transmissive surface 423. The first optical system 41 forms the first image P1 by the first light beam group L10 at the first magnifying side conjugate point F21. The second optical system 42 forms the second image P2 by the second light beam group L20 at the second magnifying side conjugate point F22. Locating the first eye 111 and the second eye 112 of the observer 100 at the first magnifying side conjugate point F21 and the second magnifying side conjugate point F22 respectively allows the observer 100 to watch the first image P1 and the second image P2. This enables the observer 100 to watch an 3D image, for example.

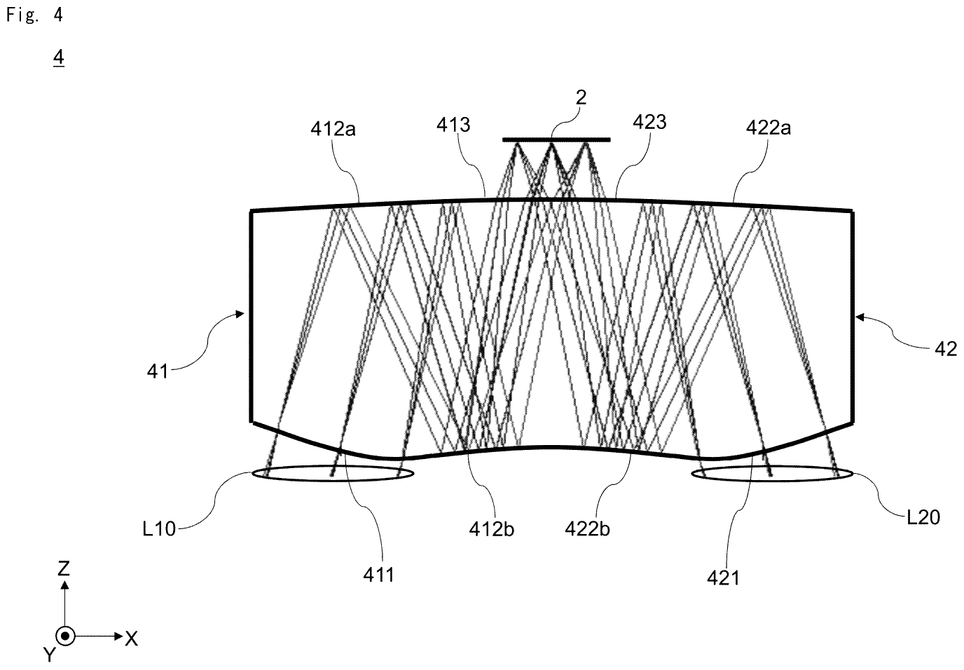

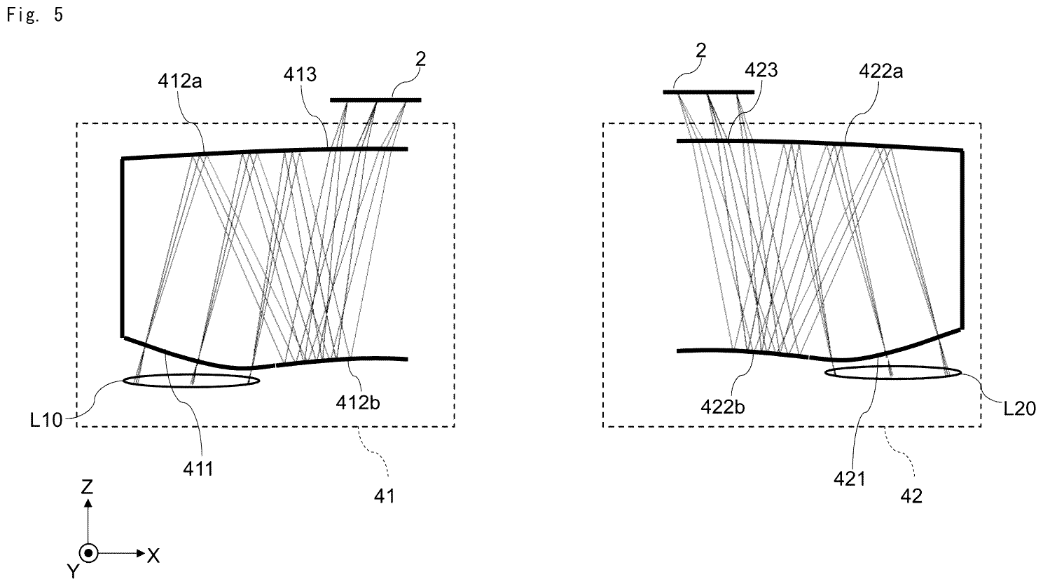

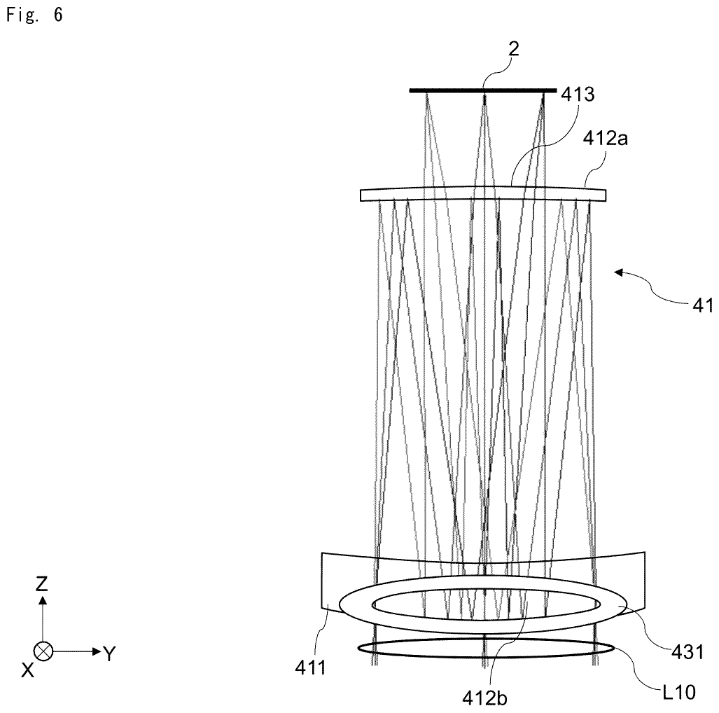

The optical system 4 will be described in detail. FIG. 4 is an explanatory view of an optical path of the optical system 4. FIG. 5 is an explanatory view of optical paths of the first optical system 41 and the second optical system 42 of the optical system 4. FIG. 6 is an explanatory view of one example of the optical path of the optical system 4. In FIG. 5, to easily distinguish the first light beam group L10 and the second light beam group L20 from each other, the first optical system 41 and the second optical system 42 are depicted as being separated in the left-right direction. FIG. 6 shows optical paths of the first light beam group L10 in a YZ plane. From FIG. 6, it is understood that the first optical system 41 allows the first light beam group L10 to converge from a first magnifying side transmissive surface 411 toward the first reducing side transmissive surface 413. As not illustrated in FIG. 6, the second optical system 42 allows the second light beam group L20 to converge from a second magnifying side transmissive surface 421 toward the second reducing side transmissive surface 423.

The first optical system 41 includes the first magnifying side transmissive surface 411, the first reflective surface group 412, and the first reducing side transmissive surface 413.

The first magnifying side transmissive surface 411 faces the first magnifying side conjugate point F21. The first magnifying side transmissive surface 411 is a transmissive surface capable of coupling the first magnifying side conjugate point F21 with the inside of the prism 40 as an optical path of a light beam group. In the present embodiment, a light beam group from the reducing side conjugate point F1 emerges from the inside of the prism 40 toward the first magnifying side conjugate point F21 by transmitting the first magnifying side transmissive surface 411. Additionally, the first magnifying side transmissive surface 411 has a convex shape toward a magnifying side. This allows a light beam group incident on the first magnifying side transmissive surface 411 to converge inside the prism 40, and thus the prism 40 can be downsized. Further, the first magnifying side transmissive surface 411 is a freeform surface a curvature of which becomes larger in the +X direction from a center and becomes smaller in the −X direction from the center. This makes it possible to effectively correct asymmetric aberrations caused by the first reflective surface group 412. The term “magnifying side” means an incident side of a light beam group in relation to a prism. The term “convex shape” for a transmissive surface means that the transmissive surface has a convex shape as a whole and may be allowed to partially include a concave or flat shape at a position not influencing a light beam group.

The first reducing side transmissive surface 413 faces the reducing side conjugate point F1. The first reducing side transmissive surface 413 is a transmissive surface capable of coupling the reducing side conjugate point F1 with the inside of the prism 40 as an optical path of a light beam group. In the present embodiment, a light beam group from the reducing side conjugate point F1 enters the prism 40 by transmitting the first reducing side transmissive surface 413.

The first reflective surface group 412 reflects a light beam group inside the prism 40 to make the first magnifying side conjugate point F21 and the reducing side conjugate point F1 be in a conjugate relation, thereby optically interconnecting the first magnifying side transmissive surface 411 and the first reducing side transmissive surface 413. In the present embodiment, the first reflective surface group 412 guides a light beam group incident on the prism 40 from the first reducing side transmissive surface 413, toward the first magnifying side transmissive surface 411.

The first reflective surface group 412 includes a first reflective surface 412a with a concave shape, and a third reflective surface 412b with a convex shape. The first reflective surface 412a reflects a light beam group so that it converges. Within the first reflective surface group 412, the first reflective surface 412a is located farthest from the first reducing side transmissive surface 413 along the first optical path L1 defined by the first optical system 41. The third reflective surface 412b is located between the first reflective surface 412a and the first reducing side transmissive surface 413 along the first optical path L1. The third reflective surface 412b reflects a light beam group from the first reducing side transmissive surface 413 toward the first reflective surface 412a. Within the first reflective surface group 412, the third reflective surface 412b is a first reducing side reflective surface located closest to the first reducing side transmissive surface 413 along the first optical path L1 defined by the first optical system 41. The term “concave shape” for a reflective surface means that the reflective surface has a concave shape as a whole and may be allowed to include a convex or flat shape at a position not influencing a light beam group. The term “convex shape” for a reflective surface means that the reflective surface has a convex shape as a whole and may be allowed to include a concave or flat shape at a position not influencing a light beam group.

The second optical system 42 includes the second magnifying side transmissive surface 421, second reflective surface group 422, and the second reducing side transmissive surface 423.

The second magnifying side transmissive surface 421 faces the second magnifying side conjugate point F22. The second magnifying side transmissive surface 421 is a transmissive surface capable of coupling the second magnifying side conjugate point F22 with the inside of the prism 40 as an optical path of a light beam group. In the present embodiment, a light beam group from the reducing side conjugate point F1 emerges from the inside of the prism 40 toward the second magnifying side conjugate point F22 by transmitting the second magnifying side transmissive surface 421. Additionally, the second magnifying side transmissive surface 421 has a convex shape toward the magnifying side. This allows a light beam group incident on the second magnifying side transmissive surface 421 to converge inside the prism 40, and thus the prism 40 can be downsized. Further, the second magnifying side transmissive surface 421 is a freeform surface a curvature of which becomes larger in the −X direction from a center and becomes smaller in the +X direction from the center. This makes it possible to effectively correct asymmetric aberrations caused by the second reflective surface group 422.

The second reducing side transmissive surface 423 faces the reducing side conjugate point F1. The second reducing side transmissive surface 423 is a transmissive surface capable of coupling the reducing side conjugate point F1 with the inside of the prism 40 as an optical path of a light beam group. In the present embodiment, a light beam group from the reducing side conjugate point F1 enters the prism 40 by transmitting the second reducing side transmissive surface 423.

The second reflective surface group 422 reflects a light beam group inside the prism 40 to make the second magnifying side conjugate point F22 and the reducing side conjugate point F1 be in a conjugate relation, thereby optically interconnecting the second magnifying side transmissive surface 421 and the second reducing side transmissive surface 423. In the present embodiment, the second reflective surface group 422 guides a light beam group incident on the prism 40 from the second reducing side transmissive surface 423, toward the second magnifying side transmissive surface 421.

The second reflective surface group 412 includes a second reflective surface 422a with a concave shape, and a fourth reflective surface 422b with a convex shape. The second reflective surface 422a reflects a light beam group so that it converges. Within the second reflective surface group 422, the second reflective surface 422a is located farthest from the second reducing side transmissive surface 423 along the second optical path L2 defined by the second optical system 42. The fourth reflective surface 422b is located between the second reflective surface 422a and the second reducing side transmissive surface 423 along the second optical path L2. The fourth reflective surface 422b reflects a light beam group from the second reducing side transmissive surface 423 toward the second reflective surface 422a. Within the second reflective surface group 422, the fourth reflective surface 422b is a second reducing side reflective surface located closest to the second reducing side transmissive surface 423 along the second optical path L2 defined by the second optical system 42.

The first reducing side reflective surface (the third reflective surface 412b) and the second reducing side reflective surface (the fourth reflective surface 422b) are located on opposite side with regard to a straight line C1 passing through a midpoint between the first reducing side transmissive surface 413 and the second reducing side transmissive surface 423 as well as the reducing side conjugate point F1. This configuration enables a light beam groups to be divided into the first light beam group L10 and the second light beam group L20 without use of half mirrors or the like. This makes it possible to reduce loss of the light beam group.

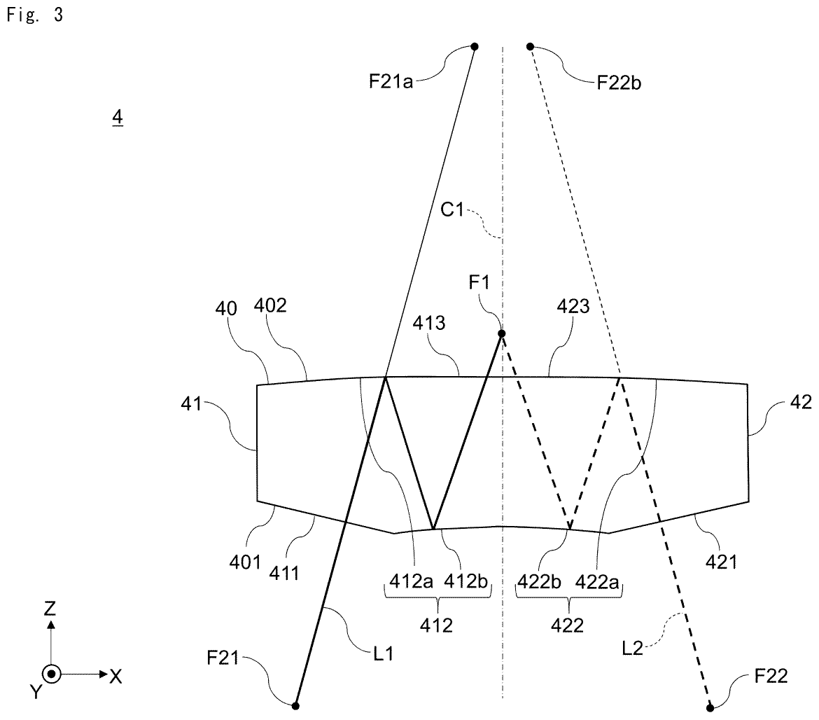

As shown in FIG. 3, the first optical system 41 and the second optical system 42 are constituted by the prism 40. The +X direction, the −X direction, the +Y direction, the −Y direction, the +Z direction, and the −Z direction are the left direction, the right direction, the upward direction, the downward direction, the far side direction, and the front side direction, with regard to the observer 100. The ±X direction, the ±Y direction, and the ±Z direction are corresponding to a length direction, a width direction, and a thickness direction of the prism 40.

The prism 40 is made of a material that is transparent in a visible light region. The prism 40 includes a first surface 401 and a second surface 402 which face each other in the thickness direction (Z direction). The first surface 401 and the second surface 402 span from an end in the +X direction to an end in the −X direction, of the prism 40.

The first magnifying side transmissive surface 411 of the first optical system 41 and the second magnifying side transmissive surface 421 of the second optical system 42 are located within the same first surface 401 being part of the prism 40 and are regions which do not overlap with each other. This can facilitate forming the prism 40 and allow its shape to be bilaterally symmetrical. The first magnifying side transmissive surface 411 and the second magnifying side transmissive surface 421 are located on opposite sides in the length direction (the ±X direction) in the first surface 401 of the prism 40.

The first reflective surface 412a of the first optical system 41 and the second reflective surface 422a of the second optical system 42 are located within the same second surface 402 being part of the prism 40 and facing each of the first magnifying side transmissive surface 411 and the second magnifying side transmissive surface 421. The first reflective surface 412a and the second reflective surface 422a are regions which do not overlap with each other. This can facilitate forming the prism 40 and allow its shape to be bilaterally symmetrical. The first reflective surface 412a and the second reflective surface 422a are located on opposite side in the length direction (the ±X direction) in the second surface 402 of the prism 40.

The third reflective surface 412b of the first optical system 41 and the fourth reflective surface 422b of the second optical system 42 are located within the same first surface 401 being part of the prism 40 and facing each of the first reflective surface 412a and the second reflective surface 422a. The third reflective surface 412b and the fourth reflective surface 422b are regions which do not overlap with each other. This can facilitate forming the prism 40 and allow its shape to be bilaterally symmetrical. The third reflective surface 412b and the fourth reflective surface 422b are located at a center in the length direction (the ±X direction) in the first surface 401 of the prism 40. In the present embodiment, the third reflective surface 412b and the fourth reflective surface 422b are located within the same first surface 401 as the first magnifying side transmissive surface 411 and the second magnifying side transmissive surface 421 are, but do not overlap with the first magnifying side transmissive surface 411 and the second magnifying side transmissive surface 421.

The first reducing side transmissive surface 413 of the first optical system 41 and the second reducing side transmissive surface 423 of the second optical system 42 are located within the same second surface 402 being part of the prism 40 and facing each of the third reflective surface 412b and the fourth reflective surface 422b. The first reducing side transmissive surface 413 and the second reducing side transmissive surface 423 are regions which partially overlap with each other. This allows decreasing a region of the prism 40 necessary for providing the first reducing side transmissive surface 413 and the second reducing side transmissive surface 423. The first reducing side transmissive surface 413 and the second reducing side transmissive surface 423 are located at a center in the length direction (the ±X direction) in the second surface 402 of the prism 40. In the present embodiment, the first reducing side transmissive surface 413 and the second reducing side transmissive surface 423 are located within the same second surface 402 as the first reflective surface 412a and the second reflective surface 422a are, but do not overlap with the first reflective surface 412a and the second reflective surface 422a.

The first optical system 41 and the second optical system 42 allow the first light beam group L10 and the second light beam group L20 to emerge in different directions. In other words, a direction in which the first light beam group L10 emerges from the first magnifying side transmissive surface 411 and a direction in which the second light beam group L20 emerges from the second magnifying side transmissive surface 421 are different from each other. This configuration allows application to configuration where light beam groups emerge in left and right directions.

The first reducing side reflective surface (the third reflective surface 412b) and the second reducing side reflective surface (the fourth reflective surface 422b) are located on opposite sides with regard to the straight line C1 passing through the midpoint between the first reducing side transmissive surface 413 and the second reducing side transmissive surface 423 as well as the reducing side conjugate point F1.

In the present embodiment, the first optical system 41 and the second optical system 42 are line-symmetric. In detail, as shown in FIG. 3, the first optical system 41 and the second optical system 42 are line-symmetric with regard to the straight line C1. This configuration allows application to configuration where light beam groups (the first light beam group L10 and the second light beam group L20) emerge in left and right directions. Especially, the optical system 4 can be easily applicable to configuration outputting light beam groups in left and right directions, such as a head-mounted display (HMD). In this context, the phrase “the first optical system 41 and the second optical system 42 are line-symmetric” is not intended to mean that the first optical system 41 and the second optical system 42 are line-symmetric in the strict sense, but mean that the first optical system 41 and the second optical system 42 are line-symmetric to allow the first optical path L1 defined by the first optical system 41 and the second optical path L2 defined by the second optical system 42 to be line-symmetric. In other words, part of the first optical system 41 which does not influence the first optical path L1 and part of the second optical system 42 which does not influence the second optical path L2 may not be line-symmetric.

In the aforementioned optical system 4, the first optical system 41 uses the first reflective surface group 412 to collect the first light beam group L10 from the display element 21 and bring it to the first eye 111 of the observer 100 to create the first image P1 there. Apparently, the optical system 4 does not include any optical element which causes large loss of light beam groups, such as a half mirror, and makes it possible to reduce loss of light beam groups (the first light beam group L10 and the second light beam group L20).

### 1.1.2. Advantageous Effects

The aforementioned optical system 4 includes the first optical system 41 and the second optical system 42 constituted by the prism 40. The first optical system 41 defines the first optical path L1 by the first light beam group L10, and includes the first reducing side transmissive surface 413 facing the reducing side conjugate point F1, the first magnifying side transmissive surface 411 which is part of the prism 40 and is located farthest from the reducing side conjugate point F1 along the first optical path L1, and the first reflective surface group 412 which reflects inside the prism 40 the first light beam group L10 with transmission of the first reducing side transmissive surface 413 and the first magnifying side transmissive surface 411 to make the reducing side conjugate point F1 and the first magnifying side conjugate point F21 be in a conjugate relation, and includes at least the first reflective surface 412a with a concave shape. The second optical system 42 defines the second optical path L2 by the second light beam group L20 different from the first light beam group L10, and includes the second reducing side transmissive surface 423 facing the reducing side conjugate point F1, the second magnifying side transmissive surface 421 which is part of the prism 40 and is located farthest from the reducing side conjugate point F1 along the second optical path L2, and the second reflective surface group 422 which reflects inside the prism 40 the second light beam group L20 with transmission of the second reducing side transmissive surface 423 and the second magnifying side transmissive surface 421 to make the reducing side conjugate point F1 and the second magnifying side conjugate point F22 be in a conjugate relation, and includes at least the second reflective surface 422a with a concave shape. The first reflective surface group 412 includes the first reducing side reflective surface (the third reflective surface 412b) which is located closest to the reducing side conjugate point F1 along the first optical path L1. The second reflective surface group 422 includes the second reducing side reflective surface (the fourth reflective surface 422b) which is located closest to the reducing side conjugate point F1 along the second optical path L2. The first reducing side reflective surface (the third reflective surface 412b) and the second reducing side reflective surface (the fourth reflective surface 422b) are located on opposite sides with regard to the straight line C1 passing through the midpoint between the first reducing side transmissive surface 413 and the second reducing side transmissive surface 423, as well as the reducing side conjugate point F1. This configuration enables reducing loss of light beam groups (the first light beam group L10 and the second light beam group L20).

In the optical system 4, the first reducing side transmissive surface 413 and the second reducing side transmissive surface 423 are located within the transmissive surface (the second surface 402) facing the reducing side conjugate point F1 and are regions which partially overlap with each other. This configuration allows decreasing a region of the prism 40 necessary for providing the first reducing side transmissive surface 413 and the second reducing side transmissive surface 423, and thus enables downsizing the prism 40.

In the optical system 4, the first reducing side reflective surface 412b and the second reducing side reflective surface 422b are located within the same first surface 401 being part of the prism 40 and facing the first reducing side transmissive surface 413 and the second reducing side transmissive surface 423, and are regions which do not overlap with each other. This configuration can facilitate forming the prism 40 and allow its shape to be bilaterally symmetrical.

In the optical system 4, the first reflective surface 412a and the second reflective surface 422a are located within the same second surface 402 being part of the prism 40 and facing each of the first magnifying side transmissive surface 411 and the second magnifying side transmissive surface 421, and are regions which do not overlap with each other. This configuration can facilitate forming the prism 40 and allow its shape to be bilaterally symmetrical.

In the optical system 4, within the first reflective surface group 412, the first reflective surface 412a is located farthest from the first reducing side transmissive surface 413 along the first optical path L1. Within the second reflective surface group 422, the second reflective surface 422a is located farthest from the second reducing side transmissive surface 423 along the second optical path L2. This configuration enables convergence or divergence of light beam groups between the first and second magnifying side conjugate points F21, F22 and the reducing side conjugate point F1.

In the optical system 4, the first reflective surface group 412 includes the third reflective surface 412b located between the first reflective surface 412a and the first reducing side transmissive surface 413 along the first optical path L1. The second reflective surface group 422 includes the fourth reflective surface 422b located between the second reflective surface 422a and the second reducing side transmissive surface 423 along the second optical path L2. The third reflective surface 412b is the first reducing side reflective surface. The fourth reflective surface 422b is the second reducing side reflective surface. This configuration enables convergence or divergence of light beam groups between the first and second magnifying side conjugate points F21, F22 and the reducing side conjugate point F1.

In the optical system 4, at least one of the first magnifying side transmissive surface 411, the first and third reflective surfaces 412a, 412b of the first reflective surface group 412, the first reducing side transmissive surface 413, the second magnifying side transmissive surface 421, the second and fourth reflective surfaces 422a, 422b of the second reflective surface group 422 or the second reducing side transmissive surface 423 includes a freeform surface. This configuration makes it possible to effectively correct asymmetric aberrations caused by the first reflective surface group 412 and the second reflective surface group 422.

The aforementioned display device 1 includes: the optical system 4, and the display unit 2 including the display element 21 located at the reducing side conjugate point F1. The display element 21 is configured to output the first light beam group L10 forming the first image P1 toward the first reducing side transmissive surface 413 and output the second light beam group L20 forming the second image P2 toward the second reducing side transmissive surface 423. The first optical system 41 forms the first image P1 by the first light beam group L10 at the first magnifying side conjugate point F21. The second optical system 42 forms the second image P2 by the second light beam group L20 at the second magnifying side conjugate point F22. This configuration enables reducing loss of light beam groups (the first light beam group L10 and the second light beam group L20). Additionally, this configuration enables display of two images by the single display element 21.

In the display device 1, the first image P1 and the second image P2 are different from each other. This configuration enables display of a 3D image, for example.

In the display device 1, the display element 21 is configured to output the first light beam group L10 and the second light beam group L20 simultaneously. The display unit 2 includes the parallax barrier 22 located between the optical system 4 and the display element 21. The parallax barrier 22 allows only the first light beam group L10 of the first light beam group L10 and the second light beam group L20 to be incident on the first reducing side transmissive surface 413, and allows only the second light beam group L20 of the first light beam group L10 and the second light beam group L20 to be incident on the second reducing side transmissive surface 423. This configuration enables display of different images by the single display element 21.

In the display device 1, the first reducing side transmissive surface 413 and the second reducing side transmissive surface 423 are located within a transmissive surface facing the reducing side conjugate point F1 and are regions which partially overlap with each other. This configuration can facilitate forming the prism 40 and allow its shape to be bilaterally symmetrical.

In the display device 1, the direction in which the first light beam group L10 emerges from the first magnifying side transmissive surface 411 and the direction in which the second light beam group L20 emerges from the second magnifying side transmissive surface 421 are different from each other. This configuration allows application to configuration where light beam groups emerge in left and right directions.

In the display device 1, the first optical system 41 and the second optical system 42 are line-symmetric with regard to the straight line C1. This configuration allows application to configuration where light beam groups emerge in left and right directions.

### 1.2. Embodiment 2

### 1.2.1 Configuration

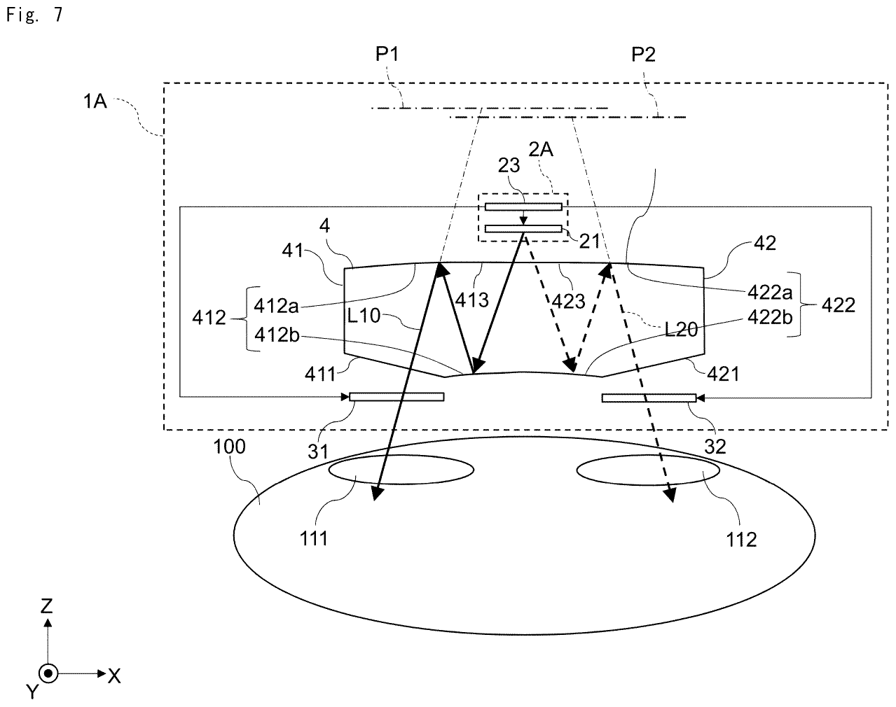

FIG. 7 is a schematic view of a configuration example of a display device 1A according to embodiment 2. The display device 1A includes a display unit 2A, a first aperture stop 31, a second aperture stop 32, and the optical system 4.

The first aperture stop 31 is located on the magnifying side of the first magnifying side transmissive surface 411 along the optical path of the first light beam group L10. In more detail, the first aperture stop 31 is located between the first magnifying side transmissive surface 411 and the first magnifying side conjugate point F21. The first aperture stop 31 is configured to open and close. In a state where the first aperture stop 31 is open, the first aperture stop 31 allows passage of a light beam group. In a state where the first aperture stop 31 is closed, the first aperture stop 31 does not allow passage of a light beam group.

The second aperture stop 32 is located on the magnifying side of the second magnifying side transmissive surface 421 along the optical path of the second light beam group L20. In more detail, the second aperture stop 32 is located between the second magnifying side transmissive surface 421 and the second magnifying side conjugate point F22. The second aperture stop 32 is configured to open and close. In a state where the second aperture stop 32 is open, the second aperture stop 32 allows passage of a light beam group. In a state where the second aperture stop 32 is closed, the second aperture stop 32 does not allow passage of a light beam group.

The display unit 2A includes the display element 21 and a control unit 23.

In the present embodiment, the control unit 23 is configured to control the display element 21, the first aperture stop 31, and the second aperture stop 32. The display unit 2A allows the first light beam group L10 to be output from the display element 21 while the first aperture stop 31 is open and the second aperture stop 32 is closed by the control unit 23 (a first time period). The display unit 2A allows the second light beam group L20 to be output from the display element 21 while the first aperture stop 31 is closed and the second aperture stop 32 is open by the control unit 23 (a second time period). The control unit 23 may be configured by a microcontroller including one or more microprocessors and memories, for example.

In the first time period, the first aperture stop 31 is open and the second aperture stop 32 is closed and thus the first light beam group L10 reaches the first eye 111 of the observer 100 but does not reach the second eye 112. In the second time period, the first aperture stop 31 is closed and the second aperture stop 32 is open and thus the second light beam group L20 reaches the second eye 112 of the observer 100 but does not reach the first eye 111. Accordingly, in the display device 1A, the first light beam group L10 from the display unit 2A in incident on only the first eye 111 of the first eye 111 and the second eye 112, and the second light beam group L20 from the display unit 2A is incident on only the second eye 112 of the first eye 111 and the second eye 112.

### 1.2.2 Advantageous Effects

The aforementioned display device 1A further includes: the first aperture stop 31 configured to open and close, the first aperture stop 31 being located on the optical path of the first light beam group L10; and the second aperture stop 32 configured to open and close, the second aperture stop 32 being located on the optical path of the second light beam group L20. The display unit 2A is configured to control the first aperture stop 31 and the second aperture stop 31 and the display element 21 in such a manner that the first light beam group L10 is output while the first aperture stop 31 is open and the second aperture stop 32 is closed and the second light beam group L20 is output while the first aperture stop 31 is closed and the second aperture stop 32 is open. This configuration enables display of different images by the single display element 21.

### 1.3 Embodiment 3

### 1.3.1 Configuration

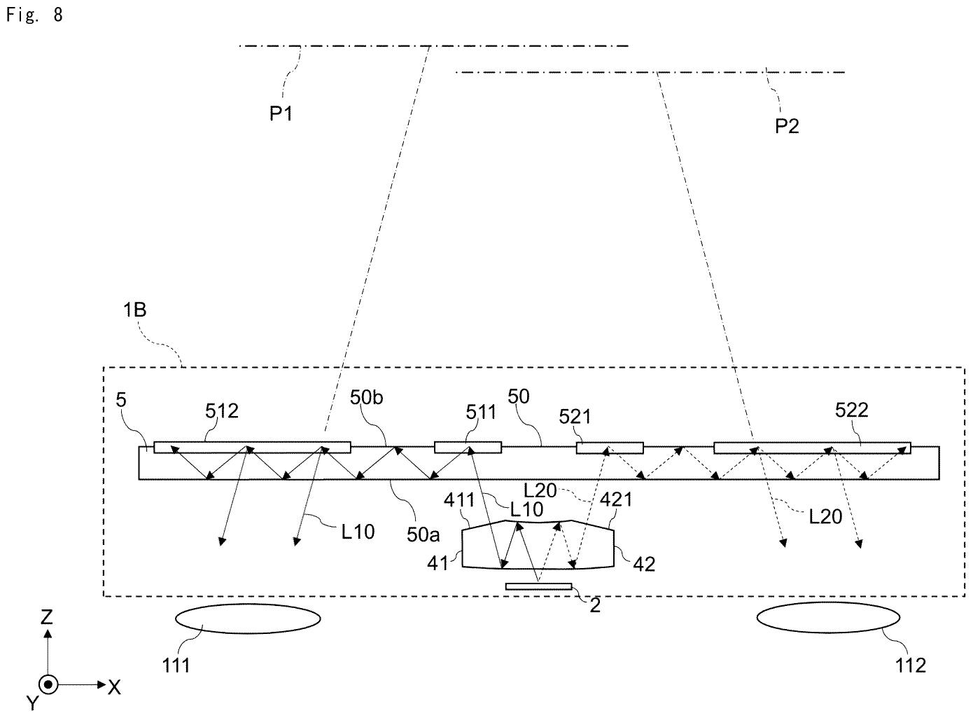

FIG. 8 is a schematic view of a configuration example of a display device 1B according to embodiment 3. The display device 1B includes the display unit 2, the optical system 4, and a light guide 5. Note that, in FIG. 8, the display unit 2 and the optical system 4 are depicted as being vertically inverted in comparison to FIG. 1.

The light guide 5 guides the first light beam group L10 output from the display unit 2 through the optical system 4, to the first eye 111 of the observer. The light guide 5 guides the second light beam group L20 output from the display unit 2 through the optical system 4, to the second eye 112 of the observer.

The light guide 5 includes a body 50, a first in-coupling region 511, a first reproduction region 512, a second in-coupling region 521, and a second reproduction region 522. In the present embodiment, the first light beam group L10 emerging from the first magnifying side transmissive surface 411 of the optical system 4 is incident on the first in-coupling region 511, and the second light beam group L20 emerging from the second magnifying side transmissive surface 421 of the optical system 4 is incident on the second in-coupling region 521.

The body 50 is made of a material that is transparent in a visible light region. Therefore, the observer 100 can visually perceive a real world via the body 50. In the present embodiment, the body 50 has a plate shape. The body 50 includes a first surface 50a and a second surface 50b in a thickness direction of the body 50. As shown in FIG. 8, the body 50 is positioned or arranged to direct the first surface 50a toward the observer (the first eye 111 and the second eye 112).

The first in-coupling region 511, the first reproduction region 512, the second in-coupling region 521, and the second reproduction region 522 are formed in or on the second surface 50b of the body 50.

The first in-coupling region 511 allows the first light beam group L10 from the optical system 4 to enter the body 50 so that the first light beam group L10 propagates inside the body 50 under a total internal reflection condition. For example, the first in-coupling region 511 allows the first light beam group L10 to enter the body 50 so that the first light beam group L10 propagates inside the body 50 in a first propagation direction (the −X direction) perpendicular to the thickness direction of the body 50. The first in-coupling region 511 is used for coupling between the optical system 4 and the light guide 5. The term “coupling” used herein means allowing propagation inside the body 50 of the light guide 5 under a total internal reflection condition.

The first reproduction region 512 divides the first light beam group L10 propagating in the first propagation direction, into a plurality of first light beam groups L10 propagating in a second propagation direction (the −Y direction) intersecting the first propagation direction, in the first propagation direction. The first reproduction region 512 further divides the plurality of first light beam groups L10 propagating in the second propagation direction, into a plurality of first light beam groups L10 toward the first eye 111, in the second propagation direction.

The first in-coupling region 511 and the first reproduction region 512 are constituted by diffraction structures causing diffraction effect for the first light beam group L10. The diffraction structures of the first in-coupling region 511 and the first reproduction region 512 are reflection surface-relief diffraction grating, for example. The diffraction structures of the first in-coupling region 511 and the first reproduction region 512 include recessed or protruded parts arranged periodically.

The second in-coupling region 521 allows the second light beam group L20 from the optical system 4 to enter the body 50 so that the second light beam group L20 propagates inside the body 50 under a total internal reflection condition. For example, the second in-coupling region 521 allows the second light beam group L20 to enter the body 50 so that the second light beam group L20 propagates inside the body 50 in a third propagation direction (the +X direction) perpendicular to the thickness direction of the body 50. The second in-coupling region 521 is used for coupling between the optical system 4 and the light guide 5.

The second reproduction region 522 divides the second light beam group L20 propagating in the third propagation direction, into a plurality of second light beam groups L20 propagating in a fourth propagation direction (the −Y direction) intersecting the third propagation direction, in the third propagation direction. The second reproduction region 522 further divides the plurality of second light beam groups L20 propagating in the third propagation direction, into a plurality of second light beam groups L20 toward the second eye 112, in the fourth propagation direction.

The second in-coupling region 521 and the second reproduction region 522 are constituted by diffraction structures causing diffraction effect for the second light beam group L20. The diffraction structures of the second in-coupling region 521 and the second reproduction region 522 are reflection surface-relief diffraction grating, for example. The diffraction structures of the second in-coupling region 521 and the second reproduction region 522 include recessed or protruded parts arranged periodically.

The light guide 5 reproduces a pupil of the first light beam group L10 in the first propagation direction and the second propagation direction to expand the pupil, by dividing, inside the body 50, the first light beam group L10 entering the body 50 from the first in-coupling region 511 into a plurality of first light beam groups L10 arranged in the first propagation direction and propagating in the second propagation direction, and further dividing each first light beam group L10 into a plurality of first light beam groups L10 arranged in the second propagation direction and traveling toward the observer 100. The light guide 5 reproduces a pupil of the second light beam group L20 in the third propagation direction and the fourth propagation direction to expand the pupil, by dividing, inside the body 50, the second light beam group L20 entering the body 50 from the second in-coupling region 521 into a plurality of second light beam groups L20 arranged in the third propagation direction and propagating in the fourth propagation direction, and further dividing each second light beam group L20 into a plurality of second light beam groups L20 arranged in the fourth propagation direction and traveling toward the observer 100.

### 1.3.2 Advantageous Effects

The display device 1B allows the first light beam group L10 and the second light beam group L20 from the optical system 4 to be incident on the first eye 111 and the second eye 112 of the observer 100 by means of the light guide 5. The display device 1 projects the first image P1 and the second image P2, which are different from each other, to the first eye 111 and the second eye 112 of the observer 100, thereby artificially inducing binocular disparity such that the observer 100 watches the image superimposed on the real world visually perceived through the body 50. The light guide 5 reproduces and expand the pupil of the first light beam group L10, as well as reproduces and expand the pupil of the second light beam group L20. Therefore, the display device 1B can expand a field of view region allowing for the observer 100 to watch the first image and the second image.

### 1.4 Embodiment 4

### 1.4.1 Configuration

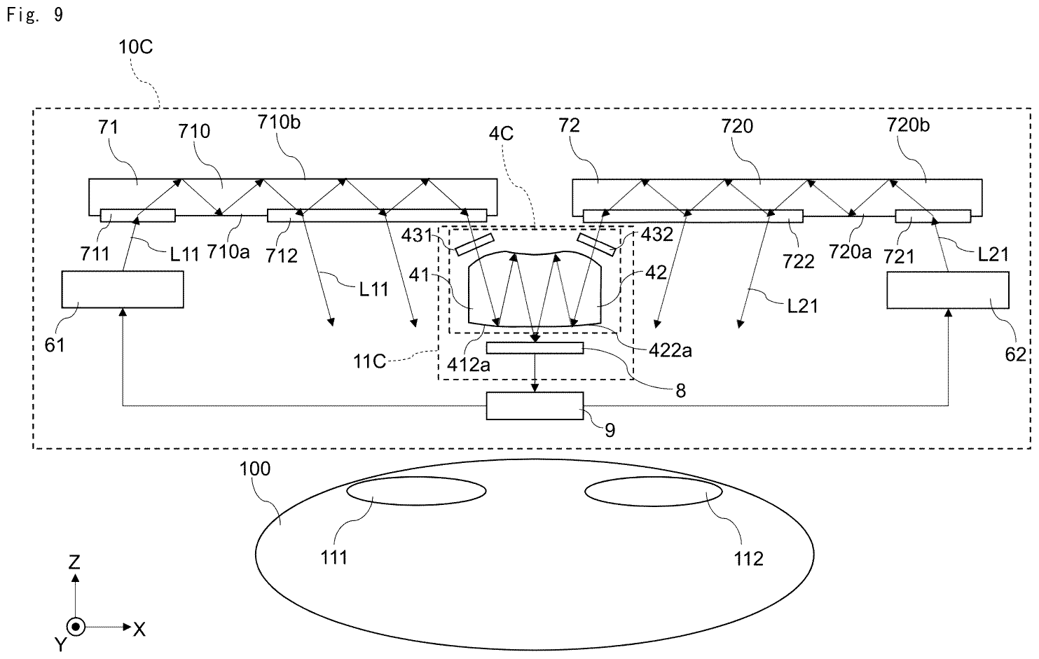

FIG. 9 is a schematic view of a configuration example of an image projection device 10C according to embodiment 4. The image projection device 10C projects images to the first eye 111 and the second eye 112 of the observer 100. In FIG. 9, the first eye 111 is a left eye and the second eye 112 is a right eye.

The image projection device 10C includes a first image unit 61, a second image unit 62, a first light guide 71, a second light guide 72, the optical system 4, an imaging element 8, and a detector 9. In the image projection device 10C, the optical system 4 and the imaging element 8 constitute an imaging device 11C.

The first image unit 61 is configured to output a first light beam group L11 forming a first image to be projected on the first eye 111 of the observer 100. The first image unit 61 outputs the first image displayed on a display, byway of a projection optical system including an optical element such as a lens. The second image unit 62 is configured to output a second light beam group L21 forming a second image to be projected on the second eye 112 of the observer 100. The second image unit 62 outputs the second image displayed on a display, by way of a projection optical system including an optical element such as a lens. Only for simplification, the first light beam group L11 and the second light beam group L21 each are depicted as a single arrow, but in fact may be a light ray with an angle corresponding to a field of view angle.

The first image and the second image may be set appropriately in accordance with the purpose or the like, of the image projection device 10C. For example, as the first image and the second image, images for augmented reality, virtual reality, or mixed reality may be used. In the present embodiment, the first image and the second image may be images superimposed or overlaid on the real world (real space). For example, the first image and the second image are set to artificially induce binocular disparity in the observer 100.

Examples of displays used in the first image unit 61 and the second image unit 62 may include known displays such as, a liquid crystal display, an organic EL display, a scanning MEMS mirror, LCOS (Liquid Crystal On Silicon), DMD (Digital Mirror Device), micro-LED, and SLM (Spatial Light Modulator).

The first and second light guides 71, 72 guide the first and second light beam groups L11, L21 output from the first and second image units 61, 62, toward the first and second eyes 111, 112 of the observer 100, respectively. The first and second light guides 71, 72 include first and second bodies 710, 720, first and second in-coupling regions 711, 721, and first and second reproduction regions 712, 722, respectively.

The first and second bodies 710, 720 are made of a material that is transparent in a visible light region. In the present embodiment, the first and second bodies 710, 720 have a plate shape. The first and second bodies 710, 720 include the first surfaces 710a, 720a and the second surfaces 710b, 720b in thickness directions of the first and second bodies 710, 720, respectively. The first and second bodies 710, 720 are positioned to direct the first surfaces 710a, 720a toward the observer 100, respectively.

The first and second in-coupling regions 711, 721 and the first and second reproduction regions 712, 722 are formed in or on the first surfaces 710a, 720a of the first and second bodies 710, 720, respectively.

The first in-coupling region 711 allows the first light beam group L11 to enter the first body 710 so that the first light beam group L11 propagates inside the first body 710 under a total internal reflection condition. For example, the first in-coupling region 711 allows the first light beam group L11 to enter the first body 710 so that the first light beam group L11 propagates inside the first body 710 in a first propagation direction (the +X direction) perpendicular to the thickness direction of the first body 710. The first in-coupling region 711 is used for coupling between the first image unit 61 and the first light guide 71. The term “coupling” used herein means allowing propagation inside the first body 710 of the first light guide 71 under a total internal reflection condition.

The first reproduction region 712 divides the first light beam group L11 propagating in the first propagation direction, into a plurality of first light beam groups L11 propagating in a second propagation direction (the −Y direction) intersecting the first propagation direction, in the first propagation direction. The first reproduction region 712 further divides the plurality of first light beam groups L11 propagating in the second propagation direction, into a plurality of first light beam groups L11 toward the observer 100, in the second propagation direction.

The first in-coupling region 711 and the first reproduction region 712 are constituted by diffraction structures causing diffraction effect for the first light beam group L11. The diffraction structures of the first in-coupling region 711 and the first reproduction region 712 are transmission surface-relief diffraction grating, for example. The diffraction structures of the first in-coupling region 711 and the first reproduction region 712 include recessed or protruded parts arranged periodically.

The first light guide 71 reproduces a pupil of the first light beam group L11 in the first propagation direction and the second propagation direction to expand the pupil, by dividing, inside the first body 710, the first light beam group L11 entering the first body 710 from the first in-coupling region 711 into a plurality of first light beam groups L11 arranged in the first propagation direction and propagating in the second propagation direction, and further dividing each first light beam group L11 into a plurality of first light beam groups L11 arranged in the second propagation direction and traveling toward the observer 100.

The second in-coupling region 721 allows the second light beam group L21 to enter the second body 720 so that the second light beam group L21 propagates inside the second body 720 under a total internal reflection condition. For example, the second in-coupling region 721 allows the second light beam group L21 to enter the second body 720 so that the second light beam group L21 propagates inside the second body 720 in a third propagation direction (the −X direction) perpendicular to the thickness direction of the second body 720. The second in-coupling region 721 is used for coupling between the second image unit 62 and the second light guide 72. The term “coupling” used herein means allowing propagation inside the second body 720 of the second light guide 72 under a total internal reflection condition.

The second reproduction region 722 divides the second light beam group L21 propagating in the third propagation direction, into a plurality of second light beam groups L21 propagating in a fourth propagation direction (the −Y direction) intersecting the third propagation direction, in the third propagation direction. The second reproduction region 722 further divides the plurality of second light beam groups L21 propagating in the fourth propagation direction, into a plurality of second light beam groups L21 toward the observer 100, in the fourth propagation direction.

The second in-coupling region 721 and the second reproduction region 722 are constituted by diffraction structures causing diffraction effect for the second light beam group L21. The diffraction structures of the second in-coupling region 721 and the second reproduction region 722 are transmission surface-relief diffraction grating, for example. The diffraction structures of the second in-coupling region 721 and the second reproduction region 722 include recessed or protruded parts arranged periodically.

The second light guide 72 reproduces a pupil of the second light beam group L21 in the third propagation direction and the fourth propagation direction to expand the pupil, by dividing, inside the second body 720, the second light beam group L21 entering the second body 720 from the second in-coupling region 721 into a plurality of second light beam groups L21 arranged in the third propagation direction and propagating in the fourth propagation direction, and further dividing each second light beam group L21 into a plurality of second light beam groups L21 arranged in the fourth propagation direction and traveling toward the observer 100.

In the present embodiment, one or some of the plurality of first light beam groups L11 traveling to the first eye 111 of the observer 100 from the first light guide 71 is incident on the optical system 4C. One or some of the plurality of second light beam groups L21 traveling to the second eye 112 of the observer 100 from the second light guide 72 is incident on the optical system 4C.

The image projection device 10C allows the first light beam group L11 from the first image unit 61 to be incident on the first eye 111 of the observer 100 by means of the first light guide 71, and allows the second light beam group L21 from the second image unit 62 to be incident on the second eye 112 of the observer 100 by means of the second light guide 72. The image projection device 10C projects the first image and the second image, which are different from each other, to the first eye 111 and the second eye 112 of the observer 100, thereby artificially inducing binocular disparity such that the observer 100 watches the image superimposed on the real world visually perceived through the first and second bodies 710 and 720. The first light guide 71 reproduces and expand the pupil of the first light beam group L11 and the second light guide 72 reproduces and expand the pupil of the second light beam group L21. Therefore, the image projection device 10C can expand a field of view region allowing for the observer 100 to watch the first image and the second image.

Here, a relation between display positions of the first image and the second image may be set to match a positional relation thereof with regard to an object in a real world visually perceived by the observer 100 via the first and second bodies 710, 720. The imaging device 11C is used for determining whether the relation between display positions of the first image by the first light beam group L11 and the second image by the second light beam L21 matches the positional relation thereof with regard to the real world visually perceived by the observer 100 via the first and second bodies 710, 720.

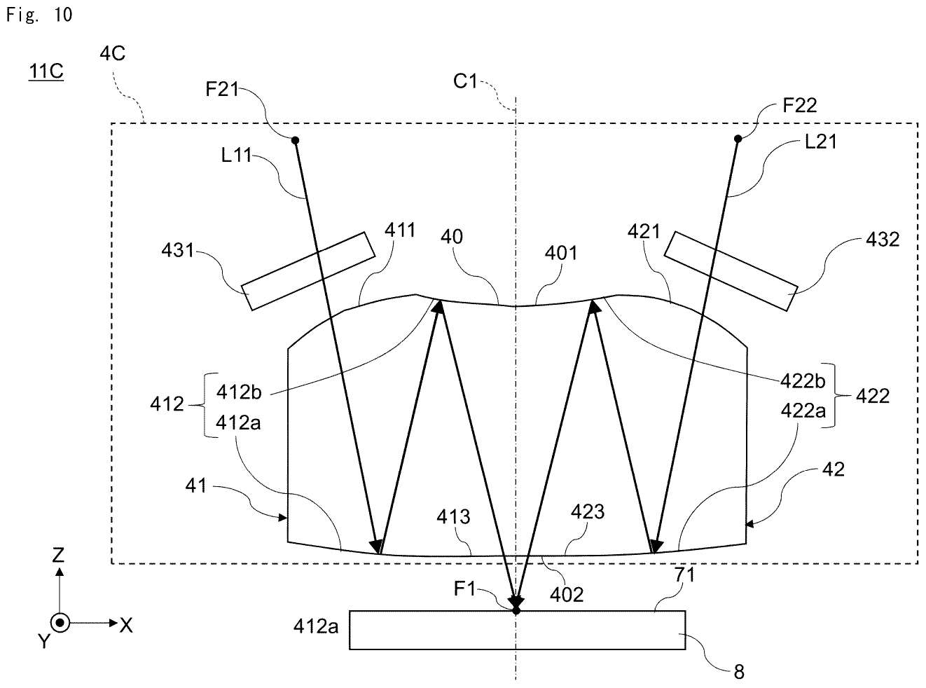

FIG. 10 is a schematic view of a configuration example of the imaging device 11C. The imaging device 11C includes the optical system 4C and the imaging element 8.

The imaging element 8 includes an imaging plane 81. The imaging element 8 may include an image sensor, for example. Examples of the image sensor may include a CMOS image sensor, a CCD image sensor, and the like.

The optical system 4C is used to allow the first light beam group L11 forming the first image to be projected on the first eye 111 of the observer 100 and the second light beam group L21 forming the second image to be projected on the second eye 112 of the observer 100 to form images on the imaging plane 81 of the imaging element 8.

Hereinafter, the optical system 4C will be described in detail. The optical system 4C includes the first optical system 41, the second optical system 42, a first aperture stop 431, and a second aperture stop 432.

The first optical system 41 and the second optical system 42 are constituted by the prism 40.

Configurations or structures of the first optical system 41 and the second optical system 42 of the optical system 4C are the same as configurations or structures of the first optical system 41 and the second optical system 42 of the optical system 4 of embodiment 1. In the optical system 4, light beam groups are incident on the first reducing side transmissive surface 413 and the second reducing side transmissive surface 423. In contrast, in the optical system 4C, light beam groups are incident on the first magnifying side transmissive surface 411 and the second magnifying side transmissive surface 421.

The light beam group from the first magnifying side conjugate point F21 enters the prism 40 by transmitting the first magnifying side transmissive surface 411. The light beam group from the first magnifying side conjugate point F21 emerges from the inside of the prism 40 toward the reducing side conjugate point F1 by transmitting the first reducing side transmissive surface 413. The first reflective surface group 412 guides the light beam group entering the prism 40 via the first magnifying side transmissive surface 411, to the first reducing side transmissive surface 413. Within the first reflective surface group 412, the third reflective surface 412b reflects the light beam group reflected by the first reflective surface 412a, toward the first reducing side transmissive surface 413.

The light beam group from the second magnifying side conjugate point F22 enters the prism 40 by transmitting the second magnifying side transmissive surface 421. The light beam group from the second magnifying side conjugate point F22 emerges from the inside of the prism 40 toward the reducing side conjugate point F1 by transmitting the second reducing side transmissive surface 423. The second reflective surface group 422 guides the light beam group entering the prism 40 via the second magnifying side transmissive surface 421, to the second reducing side transmissive surface 423. Within the second reflective surface group 422, the fourth reflective surface 422b reflects the light beam group reflected by the second reflective surface 422a, toward the second reducing side transmissive surface 423.

In the present embodiment, the optical system 4C is located to allow the first light beam group L11 forming the first image to be incident on the first magnifying side transmissive surface 411 from the first magnifying side conjugate point F21 and to allow the second light beam group L21 forming the second image to be incident on the second magnifying side transmissive surface 421 from the second magnifying side conjugate point F22. In the present embodiment, one or some of the plurality of first light beam groups L11 traveling from the first light guide 71 toward the first eye 111 of the observer 100 is incident on the first magnifying side transmissive surface 411. One or some of the plurality of second light beam groups L21 traveling from the second light guide 72 toward the second eye 112 of the observer 100 is incident on the second magnifying side transmissive surface 421. The first optical system 41 forms the first image by the first light beam group L11 at the reducing side conjugate point F1. The second optical system 42 forms the second image by the second light beam L21 at the reducing side conjugate point F1. The imaging element 8 is located at the reducing side conjugate point F1 of the optical system 4C. Therefore, the first image by the first light beam group L11 and the second image by the second light beam L21 are formed on the imaging plane 81 of the imaging element 8.

As shown in FIG. 10, the first optical system 41 and the second optical system 42 allow the first light beam group L11 and the second light beam L21 to be incident on the imaging plane 81 in different directions. In other words, in the imaging device 11C, a direction in which the first light beam group L11 is incident on the first magnifying side transmissive surface 411 and a direction in which the second light beam L21 is incident on the second magnifying side transmissive surface 421 are different from each other. This configuration allows application to configuration where light beam groups are incident on in left and right directions.

The first aperture stop 431 is located on the magnifying side of the first magnifying side transmissive surface 411. In more detail, the first aperture stop 431 is located between the first magnifying side conjugate point F21 and the first magnifying side transmissive surface 411. The first aperture stop 431 is configured to limit a light beam group incident on the first magnifying side transmissive surface 411. A size of an aperture of the first aperture stop 431 is set to prohibit unnecessary light other than the first light beam group L11 from entering the first optical system 41. Providing the first aperture stop 431 can reduce the likelihood of unnecessary light entering the first optical system 41. Locating the first aperture stop 431 on the magnifying side of the first magnifying side transmissive surface 411 can reduce an effective diameter of the first magnifying side transmissive surface 411, resulting in preventing unnecessary light from entering the imaging plane 81.

The second aperture stop 432 is located on the magnifying side of the second magnifying side transmissive surface 421. In more detail, the second aperture stop 432 is located between the second magnifying side conjugate point F22 and the second magnifying side transmissive surface 421. The second aperture stop 432 is configured to limit a light beam group incident on the second magnifying side transmissive surface 421. A size of an aperture of the second aperture stop 432 is set to prohibit unnecessary light other than the second light beam group L21 from entering the second optical system 42. Providing the second aperture stop 432 can reduce the likelihood of unnecessary light entering the second optical system 42. Locating the second aperture stop 432 on the magnifying side of the second magnifying side transmissive surface 421 can reduce an effective diameter of the second magnifying side transmissive surface 421, resulting in preventing unnecessary light from entering the imaging plane 81.

In the aforementioned optical system 4C, the first optical system 41 allows the first light beam group L11 to form the first image on the imaging plane 81, by use of the first reflective surface group 412. The second optical system 42 allows the second light beam group L21 to form the second image on the imaging plane 81, by use of the second reflective surface group 422. Apparently, the optical system 4C does not include any optical element which causes large loss of light beam groups, such as a half mirror, and makes it possible to reduce loss of light beam groups (the first light beam group L11 and the second light beam group L21).

The detector 9 is configured to perform a detection process. The detection process detects a positional relation between the first image and the second image, from a positional relation between an image point of the first optical system 41 and an image point of the second optical system 42 based on the first image and the second image obtained from the imaging plane 81. The detector 9 enables confirmation of positional accuracies of the first image and the second image. The detector 9 may be configured by a microcontroller including one or more microprocessors and memories, for example. The detector 9 may be configured by an FPGA (Field-Programmable Gate Array), an ASIC (Application Specific Integrated Circuit), or the like, for example.

Due to the detector 9, the positional relation between the first image and the second image is obtained. The positional relation between the first image and the second image can be used for a calibration process. The calibration process is a process of allowing a relation between the display positions of the first image by the first light beam group L11 and the second image by the second light beam group L21 to satisfy a condition of the observer 100 capable of visually perceiving a 3D image. As one example, the detector 9 can adjust a direction of the first light beam group L11 from the first image unit 61 and a direction of the second light beam L21 from the second image unit 62 to locate the display positions of the first image by the first light beam group L11 and the second image by the second light beam group L21 in an acceptable range.

### 1.4.2 Advantageous Effects

The aforementioned optical system 4 includes the first optical system 41 and the second optical system 42 which are constituted by the prism 40. The first optical system 41 defines the first optical path L1 by the first light beam group L10, and includes: the first reducing side transmissive surface 413 facing the reducing side conjugate point F1; the first magnifying side transmissive surface 411 which is part of the prism 40 and is located farthest from the reducing side conjugate point F1 along the first optical path L1; and the first reflective surface group 412 which reflects inside the prism 40 the first light beam group L10 with transmission of the first reducing side transmissive surface 413 and the first magnifying side transmissive surface 411 to make the reducing side conjugate point F1 and the first magnifying side conjugate point F21 be in a conjugate relation, and includes at least the first reflective surface 412a with a concave shape. The second optical system 42 defines the second optical path L2 by the second light beam group L20 different from the first light beam group L10, and includes: the second reducing side transmissive surface 423 facing the reducing side conjugate point F1; the second magnifying side transmissive surface 421 which is part of the prism 40 and is located farthest from the reducing side conjugate point F1 along the second optical path L2; and the second reflective surface group 422 which reflects inside the prism 40 the second light beam group L20 with transmission of the second reducing side transmissive surface 423 and the second magnifying side transmissive surface 421 to make the reducing side conjugate point F1 and the second magnifying side conjugate point F22 be in a conjugate relation, and includes at least the second reflective surface 422a with a concave shape. The first reflective surface group 412 includes the first reducing side reflective surface (the third reflective surface 412b) which is located closest to the reducing side conjugate point F1 along the first optical path L1. The second reflective surface group 422 includes the second reducing side reflective surface (the fourth reflective surface 422b) which is located closest to the reducing side conjugate point F1 along the second optical path L2. The first reducing side reflective surface (the third reflective surface 412b) and the second reducing side reflective surface (the fourth reflective surface 422b) are located on opposite side with regard to the straight line C1 passing through the midpoint between the first reducing side transmissive surface 413 and the second reducing side transmissive surface 423 as well as the reducing side conjugate point F1. This configuration enables reducing loss of light beam groups.

In the optical system 4, the first reducing side transmissive surface 413 and the second reducing side transmissive surface 423 are located within a transmissive surface (the second surface 402) facing the reducing side conjugate point F1 and are regions which partially overlap with each other. This configuration allows decreasing a region of the prism 40 necessary for providing the first reducing side transmissive surface 413 and the second reducing side transmissive surface 423, and thus enables downsizing the prism 40.

In the optical system 4, the first reducing side reflective surface 412b and the second reducing side reflective surface 422b are located within the same first surface 401 being part of the prism 40 and facing each of the first reducing side transmissive surface 413 and the second reducing side transmissive surface 423, and regions which do not overlap with each other. This configuration can facilitate forming the prism 40 and allow its shape to be bilaterally symmetrical.

In the optical system 4, the first reflective surface 412a and the second reflective surface 422a are located within the same surface (the second surface 402) being part of the prism 40 and facing each of the first magnifying side transmissive surface 411 and the second magnifying side transmissive surface 421, and are regions which do not overlap with each other. This configuration can facilitate forming the prism 40 and allow its shape to be bilaterally symmetrical.

In the optical system 4, within the first reflective surface group 412, the first reflective surface 412a is located farthest from the first reducing side transmissive surface 413 along the first optical path L1. Within the second reflective surface group 422, the second reflective surface 422a is located farthest from the second reducing side transmissive surface 423 along the second optical path L2. This configuration enables convergence or divergence of light beam groups between the first and second magnifying side conjugate points F21, F22 and the reducing side conjugate point F1.

In the optical system 4, the first reflective surface group 412 includes the third reflective surface 412b located between the first reflective surface 412a and the first reducing side transmissive surface 413 along the first optical path L1. The second reflective surface group 422 includes the fourth reflective surface 422b located between the second reflective surface 422a and the second reducing side transmissive surface 423 along the second optical path L2. The third reflective surface 412b is the first reducing side reflective surface. The fourth reflective surface 422b is the second reducing side reflective surface. This configuration enables convergence or divergence of light beam groups between the first and second magnifying side conjugate points F21, F22 and the reducing side conjugate point F1.

In the optical system 4, at least one of the first magnifying side transmissive surface 411, the first reflective surface group 412, the first reducing side transmissive surface 413, the second magnifying side transmissive surface 421, the second reflective surface group 422, or the second reducing side transmissive surface 423 includes a freeform surface. This configuration enables improvement of the degree of freedom of design of the prism 40.

The aforementioned imaging device 11C includes the optical system 4C, and the imaging element 8 located at the reducing side conjugate point F1. The optical system 4C is positioned or located to allow the first light beam group L11 forming the first image to be incident on the first magnifying side transmissive surface 411 from the first magnifying side conjugate point F21 as well as to allow the second light beam L21 forming the second image to be incident on the second magnifying side transmissive surface 421 from the second magnifying side conjugate point F22. The first optical system 41 forms the first image by the first light beam group L11, at the imaging element 8. The second optical system 42 forms the second image by the second light beam L21, at the imaging element 8. This configuration enables reducing loss of light beam groups. Additionally, this configuration allows a single imaging element to capture two images.

In the imaging device 11C, a direction in which the first light beam group L11 is incident on the first magnifying side transmissive surface 411 and a direction in which the second light beam L21 is incident on the second magnifying side transmissive surface 421 are different from each other. This configuration allows application to configuration where light beam groups are incident in left and right directions.

In the imaging device 11C, the first optical system 41 and the second optical system 42 are line-symmetric with regard to the straight line C1. This configuration allows application to configuration where light beam groups are incident in left and right directions.

### 1.5 Embodiment 5

### 1.5.1 Configuration

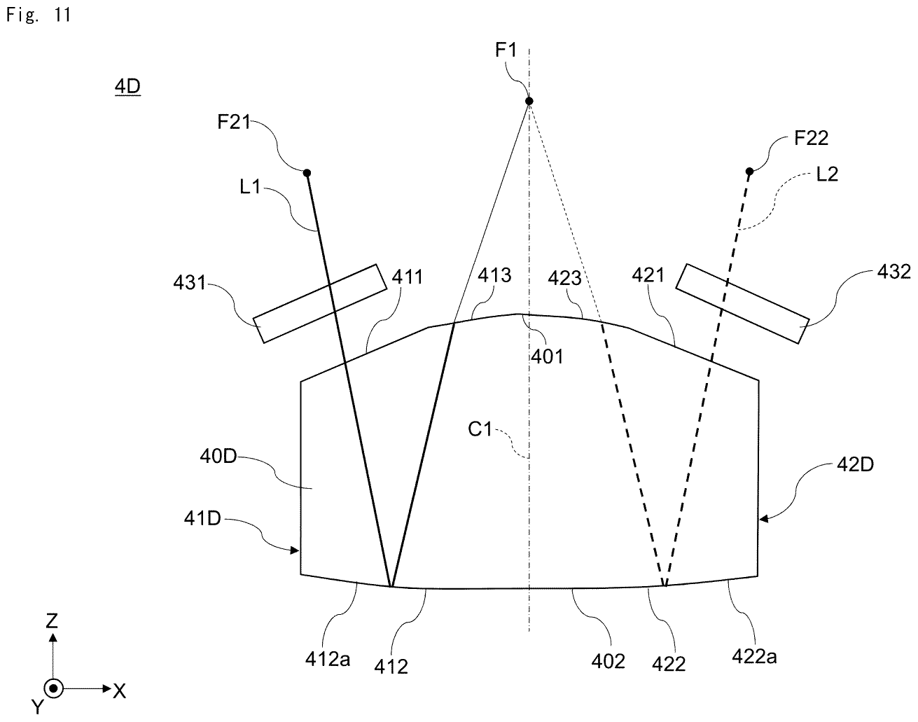

FIG. 11 is a schematic view of a configuration example of an optical system 4D according to embodiment 5. The optical system 4D can be used instead of the optical system 4 in the display devices 1, 1A, 1B of embodiment 1 to 3, or instead of the optical system 4C in the imaging device 11C of embodiment 4.

The optical system 4D includes a first optical system 41D and a second optical system 42D.

In the optical system 4D, the first optical system 41D and the second optical system 42D are constituted by a prism 40D.

The first optical system 41D defines the first magnifying side conjugate point F21 outside the prism 40D with regard to the reducing side conjugate point F1 outside the prism 40D. The first optical system 41D defines the first optical path L1 between the reducing side conjugate point F1 and the first magnifying side conjugate point F21. In the present embodiment, the first magnifying side conjugate point F21 is located at infinity, but only for simplification, it is depicted as an arbitrary point. Note that, the first magnifying side conjugate point F21 may not be located at infinity but may be adjusted to be located at a finite distance in accordance with visual acuity of the observer 100.

The second optical system 42D defines the second magnifying side conjugate point F22 outside the prism 40D with regard to the reducing side conjugate point F1 outside the prism 40D. The second magnifying side conjugate point F22 is different from the first magnifying side conjugate point F21. The second optical system 42D defines the second optical path L2 between the reducing side conjugate point F1 and the second magnifying side conjugate point F22. In the present embodiment, the second magnifying side conjugate point F22 is located at infinity, but only for simplification, it is depicted as an arbitrary point. Note that, the second magnifying side conjugate point F22 may not be located at infinity but may be adjusted to be located at a finite distance in accordance with visual acuity of the observer 100.

The first optical system 41D includes the first magnifying side transmissive surface 411, the first reflective surface group 412, and the first reducing side transmissive surface 413. The first reflective surface group 412 includes the first reflective surface 412a. The first reflective surface 412a reflects a light beam group from the first magnifying side transmissive surface 411 toward the first reducing side transmissive surface 413. The first reflective surface 412a reflects a light beam group from the first reducing side transmissive surface 413 toward the first magnifying side transmissive surface 411. Within the first reflective surface group 412, the first reflective surface 412a is the first reducing side reflective surface located closest to the first reducing side transmissive surface 413 along the first optical path L1 defined by the first optical system 41.

The second optical system 42D includes the second magnifying side transmissive surface 421, the second reflective surface group 422, and the second reducing side transmissive surface 423. The second reflective surface group 422 includes the second reflective surface 422a. The second reflective surface 422a reflects a light beam group from the second magnifying side transmissive surface 421 toward the second reducing side transmissive surface 423. The second reflective surface 422a reflects a light beam group from the second reducing side transmissive surface 423 toward the second magnifying side transmissive surface 421. Within the second reflective surface group 422, the second reflective surface 422a is the second reducing side reflective surface located closest to the second reducing side transmissive surface 423 along the second optical path L2 defined by the second optical system 42.

The first reducing side reflective surface (the first reflective surface 412a) and the second reducing side reflective surface (the second reflective surface 422a) are located on opposite side with regard to the straight line C1 passing through the midpoint between the first reducing side transmissive surface 413 and the second reducing side transmissive surface 423 as well as the reducing side conjugate point F1. This configuration enables reducing loss of light beam groups.

As shown i FIG. 11, the first optical system 41D and the second optical system 42D are constituted by the prism 40D.

The prism 40D includes the first surface 401 and the second surface 402 which face each other in the thickness direction (the ±Z direction). In the present embodiment, the first optical system 41D and the second optical system 42D are configured to locate the reducing side conjugate point F1, the first magnifying side conjugate point F21, and the second magnifying side conjugate point F22 on a side of the first surface 401 of the prism 40D.

The first magnifying side transmissive surface 411 of the first optical system 41D and the second magnifying side transmissive surface 421 of the second optical system 42D are located within the same first surface 401 of the prism 40D. The first magnifying side transmissive surface 411 and the second magnifying side transmissive surface 421 are regions which do not overlap with each other. This can facilitate forming the prism 40D and allow its shape to be bilaterally symmetrical. The first magnifying side transmissive surface 411 and the second magnifying side transmissive surface 421 are located on opposite sides in the length direction (the X direction) in the first surface 401 of the prism 40D.

The first reflective surface 412a of the first optical system 41D and the second reflective surface 422a of the second optical system 42D are located within the same second surface 402 being part of the prism 40D and facing each of the first magnifying side transmissive surface 411 and the second magnifying side transmissive surface 421. The first reflective surface 412a and the second reflective surface 422a are regions which do not overlap with each other. This can facilitate forming the prism 40D and allow its shape to be bilaterally symmetrical. The first reflective surface 412a and the second reflective surface 422a are located on opposite sides in the length direction (the ±X direction) in the second surface 402 of the prism 40D.

The first reducing side transmissive surface 413 of the first optical system 41D and the second reducing side transmissive surface 423 of the second optical system 42D are located within the same first surface 401 being part of the prism 40D and facing each of the first reflective surface 412a and the second reflective surface 422a. The first reducing side transmissive surface 413 and the second reducing side transmissive surface 423 are regions which partially overlap with each other. This allows decreasing a region of the prism 40D necessary for providing the first reducing side transmissive surface 413 and the second reducing side transmissive surface 423. The first reducing side transmissive surface 413 and the second reducing side transmissive surface 423 are located at a center in the length direction (the ±X direction) in the first surface 401 of the prism 40D. In the present embodiment, the first reducing side transmissive surface 413 and the second reducing side transmissive surface 423 are located within the same first surface 401 as the first magnifying side transmissive surface 411 and the second magnifying side transmissive surface 421 are, but do not overlap with the first magnifying side transmissive surface 411 and the second magnifying side transmissive surface 421.

### 1.5.2 Advantageous Effects

The aforementioned optical system 4D includes the first optical system 41D and the second optical system 42D which are constituted by the prism 40D. The first optical system 41D defines the first optical path L1 by the first light beam group, and includes the first reducing side transmissive surface 413 facing the reducing side conjugate point F1, the first magnifying side transmissive surface 411 which is part of the prism 40D and is located farthest from the reducing side conjugate point F1 along the first optical path L1, and the first reflective surface group 412 which reflects inside the prism 40D the first light beam group with transmission of the first reducing side transmissive surface 413 and the first magnifying side transmissive surface 411 to make the reducing side conjugate point F1 and the first magnifying side conjugate point F21 be in a conjugate relation, and includes at least the first reflective surface 412a with a concave shape. The second optical system 42D defines the second optical path L2 by the second light beam group different from the first light beam group, and includes the second reducing side transmissive surface 423 facing the reducing side conjugate point F1, the second magnifying side transmissive surface 421 which is part of the prism 40D and is located farthest from the reducing side conjugate point F1 along the second optical path L2, and the second reflective surface group 422 which reflects inside the prism 40D the second light beam group with transmission of the second reducing side transmissive surface 423 and the second magnifying side transmissive surface 421 to make the reducing side conjugate point F1 and the second magnifying side conjugate point F22 be in a conjugate relation, and includes at least the second reflective surface 422a with a concave shape. The first reflective surface group 412 includes the first reducing side reflective surface (the first reflective surface 412a) which is located closest to the reducing side conjugate point F1 along the first optical path L1. The second reflective surface group 422 includes the second reducing side reflective surface (the second reflective surface 422a) which is located closest to the reducing side conjugate point F1 along the second optical path L2. The first reducing side reflective surface (the first reflective surface 412a) and the second reducing side reflective surface (the second reflective surface 422a) are located on opposite sides with regard to the straight line C1 passing through the midpoint between the first reducing side transmissive surface 413 and the second reducing side transmissive surface 423, as well as the reducing side conjugate point F1. This configuration enables reducing loss of light beam groups (the first light beam group and the second light beam group).

In the optical system 4, the first reflective surface 412a is the first reducing side reflective surface, and the second reflective surface 422a is the second reducing side reflective surface. This configuration can facilitate forming the prism 40D and allow its shape to be bilaterally symmetrical. Further, this configuration can downsize the prism 40D.

### 1.6 Embodiment 6

### 1.6.1 Configuration

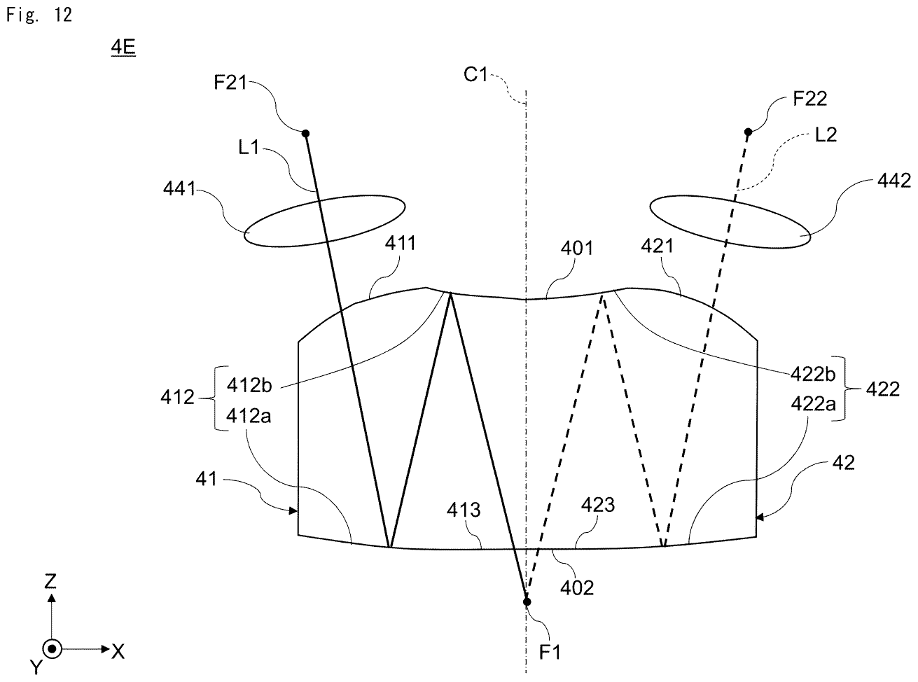

FIG. 12 is a schematic view of a configuration example of an optical system 4E according to embodiment 6. The optical system 4E can be used instead of the optical system 4 in the display devices 1, 1A, 1B of embodiment 1 to 3, or instead of the optical system 4C in the imaging device 11C of embodiment 4.

The optical system 4E includes the first optical system 41, the second optical system 42, a first converging optical system 441, and a second converging optical system 442.

The first converging optical system 441 is located outside the prism 40 to face the first magnifying side transmissive surface 411. In other words, the first converging optical system 441 is located on the magnifying side of the first magnifying side transmissive surface 411. In more detail, the first converging optical system 441 is located between the first magnifying side conjugate point F21 and the first magnifying side transmissive surface 411. The first converging optical system 441 includes one or more optical elements, for example. Examples of the one or more optical elements may include a condenser lens, but are not limited thereto. The first converging optical system 441 allows a light beam group from the first magnifying side conjugate point F21 to converge at the first magnifying side transmissive surface 411. Providing the first converging optical system 441 enables downsizing the first optical system 41.

The second converging optical system 442 is located outside the prism 40 to face the second magnifying side transmissive surface 421. In other words, the second converging optical system 442 is located on the magnifying side of the second magnifying side transmissive surface 421. In more detail, the second converging optical system 442 is located between the second magnifying side conjugate point F22 and the second magnifying side transmissive surface 421. The second converging optical system 442 allows a light beam group from the second magnifying side conjugate point F22 to converge at the second magnifying side transmissive surface 421. The second converging optical system 442 includes one or more optical elements, for example. Examples of the one or more optical elements may include a condenser lens, but are not limited thereto. Providing the second converging optical system 442 enables downsizing the second optical system 42.

### 1.6.2 Advantageous Effects

The aforementioned optical system 4E includes the first optical system 41 and the second optical system 42 which are constituted by the prism 40. The first optical system 41 defines the first optical path L1 by the first light beam group L10, and includes the first reducing side transmissive surface 413 facing the reducing side conjugate point F1, the first magnifying side transmissive surface 411 which is part of the prism 40 and is located farthest from the reducing side conjugate point F1 along the first optical path L1, and the first reflective surface group 412 which reflects inside the prism 40 the first light beam group L10 with transmission of the first reducing side transmissive surface 413 and the first magnifying side transmissive surface 411 to make the reducing side conjugate point F1 and the first magnifying side conjugate point F21 be in a conjugate relation, and includes at least the first reflective surface 412a with a concave shape. The second optical system 42 defines the second optical path L2 by the second light beam group L20 different from the first light beam group L10, and includes the second reducing side transmissive surface 423 facing the reducing side conjugate point F1, the second magnifying side transmissive surface 421 which is part of the prism 40 and is located farthest from the reducing side conjugate point F1 along the second optical path L2, and the second reflective surface group 422 which reflects inside the prism 40 the second light beam group L20 with transmission of the second reducing side transmissive surface 423 and the second magnifying side transmissive surface 421 to make the reducing side conjugate point F1 and the second magnifying side conjugate point F22 be in a conjugate relation, and includes at least the second reflective surface 422a with a concave shape. The first reflective surface group 412 includes the first reducing side reflective surface (the third reflective surface 412b) which is located closest to the reducing side conjugate point F1 along the first optical path L1. The second reflective surface group 422 includes the second reducing side reflective surface (the fourth reflective surface 422b) which is located closest to the reducing side conjugate point F1 along the second optical path L2. The first reducing side reflective surface (the third reflective surface 412b) and the second reducing side reflective surface (the fourth reflective surface 422b) are located on opposite sides with regard to the straight line C1 passing through the midpoint between the first reducing side transmissive surface 413 and the second reducing side transmissive surface 423, as well as the reducing side conjugate point F1. This configuration enables reducing loss of light beam groups (the first light beam group and the second light beam group).

### 1.7 Embodiment 7

### 1.7.7 Configuration

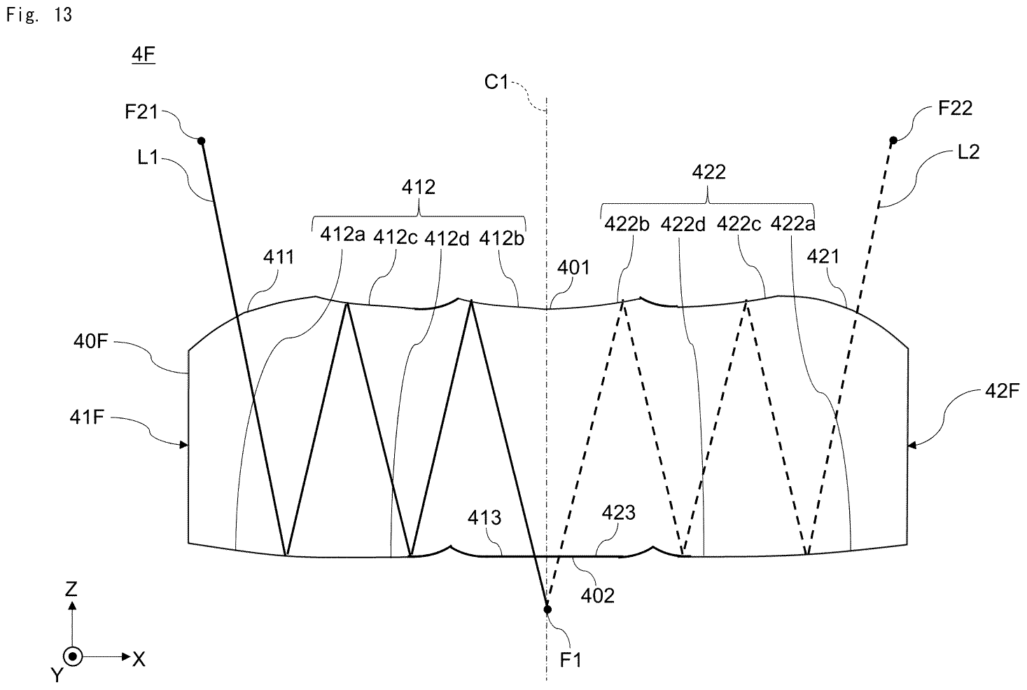

FIG. 13 is a schematic view of a configuration example of an optical system 4F according to embodiment 7. The optical system 4F can be used instead of the optical system 4 in the display devices 1, 1A, 1B of embodiment 1 to 3, or instead of the optical system 4C in the imaging device 11C of embodiment 4.

The optical system 4F includes a first optical system 41F and a second optical system 42F.

In the optical system 4F, the first optical system 41F and the second optical system 42F are constituted by a prism 40F.

The first optical system 41F defines the first magnifying side conjugate point F21 outside the prism 40F with regard to the reducing side conjugate point F1 outside the prism 40F. The first optical system 41F defines the first optical path L1 between the reducing side conjugate point F1 and the first magnifying side conjugate point F21. In the present embodiment, the first magnifying side conjugate point F21 is located at infinity, but only for simplification, it is depicted as an arbitrary point. Note that, the first magnifying side conjugate point F21 may not be located at infinity but may be adjusted to be located at a finite distance in accordance with visual acuity of the observer.

The second optical system 42F defines the second magnifying side conjugate point F22 outside the prism 40F with regard to the reducing side conjugate point F1 outside the prism 40F. The second magnifying side conjugate point F22 is different from the first magnifying side conjugate point F21. The second optical system 42F defines the second optical path L2 between the reducing side conjugate point F1 and the second magnifying side conjugate point F22. In the present embodiment, the second magnifying side conjugate point F22 is located at infinity, but only for simplification, it is depicted as an arbitrary point. Note that, the second magnifying side conjugate point F22 may not be located at infinity but may be adjusted to be located at a finite distance in accordance with visual acuity of the observer.

The first optical system 41F includes the first magnifying side transmissive surface 411, the first reflective surface group 412, and the first reducing side transmissive surface 413.

The first reflective surface group 412 includes the first reflective surface 412a, the third reflective surface 412b, a fifth reflective surface 412c, and a seventh reflective surface 412d.

The fifth reflective surface 412c is located between the first reflective surface 412a and the third reflective surface 412b along the first optical path L1. The seventh reflective surface 412d is located between the fifth reflective surface 412c and the third reflective surface 412b along the first optical path L1. The fifth reflective surface 412c reflects a light beam group from the first reflective surface 412a toward the seventh reflective surface 412d. The fifth reflective surface 412c reflects a light beam group from the seventh reflective surface 412d toward the first reflective surface 412a. The seventh reflective surface 412d reflects a light beam group from the fifth reflective surface 412c toward the third reflective surface 412b. The seventh reflective surface 412d reflects a light beam group from the third reflective surface 412b toward the fifth reflective surface 412c.

In the first optical system 41F, within the first reflective surface group 412, the first reflective surface 412a is located farthest from the first reducing side transmissive surface 413 along the first optical path L1 defined by the first optical system 41F. Within the first reflective surface group 412, the third reflective surface 412b is the first reducing side reflective surface located closest to the first reducing side transmissive surface 413 along the first optical path L1 defined by the first optical system 41F. The first reflective surface group 412 further including the fifth reflective surface 412c and the seventh reflective surface 412d can increase an optical path length between the first magnifying side transmissive surface 411 and the first reducing side transmissive surface 413. This enables improvement of the degree of freedom of arrangement of the optical system 4F.

The second optical system 42F includes the second magnifying side transmissive surface 421, the second reflective surface group 422, and the second reducing side transmissive surface 423.

The second reflective surface group 422 includes the second reflective surface 422a, the fourth reflective surface 422b, a sixth reflective surface 422c, and an eighth reflective surface 422d.

The sixth reflective surface 422c is located between the second reflective surface 422a and the fourth reflective surface 422b along the second optical path L2. The eighth reflective surface 422d is located between the sixth reflective surface 422c and the fourth reflective surface 422b along the second optical path L2. The sixth reflective surface 422c reflects a light beam group from the second reflective surface 422a toward the eighth reflective surface 422d. The sixth reflective surface 422c reflects a light beam group from the eighth reflective surface 422d toward the second reflective surface 422a. The eighth reflective surface 422d reflects a light beam group from the sixth reflective surface 422c toward the fourth reflective surface 422b. The eighth reflective surface 422d reflects a light beam group from the fourth reflective surface 422b toward the sixth reflective surface 422c.

In the second optical system 42F, within the second reflective surface group 422, the second reflective surface 422a is located farthest from the second reducing side transmissive surface 423 along the second optical path L2 defined by the second optical system 42F. Within the second reflective surface group 422, the fourth reflective surface 422b is the second reducing side reflective surface located closest to the second reducing side transmissive surface 423 along the second optical path L2 defined by the second optical system 42F. The second reflective surface group 422 further including the sixth reflective surface 422c and the eighth reflective surface 422d can increase an optical path length between the second magnifying side transmissive surface 421 and the second reducing side transmissive surface 423. This enables improvement of the degree of freedom of arrangement of the optical system 4F.

The first reducing side reflective surface (the third reflective surface 412b) and the second reducing side reflective surface (the fourth reflective surface 422b) are located on opposite side with regard to the straight line C1 passing through the midpoint between the first reducing side transmissive surface 413 and the second reducing side transmissive surface 423 as well as the reducing side conjugate point F1. This configuration enables reducing loss of light beam groups.

The first optical system 41F and the second optical system 42F are constituted by the prism 40F.

The prism 40F includes the first surface 401 and the second surface 402 facing each other in the thickness direction (the ±Z direction). In the present embodiment, the first optical system 41F and the second optical system 42F are configured so that the reducing side conjugate point F1 is present on a side of the second surface 402 of the prism 40F and the first magnifying side conjugate point F21 and the second magnifying side conjugate point F22 are present on a side of the first surface 401 of the prism 40F.

The first magnifying side transmissive surface 411 of the first optical system 41F and the second magnifying side transmissive surface 421 of the second optical system 42F are located within the same first surface 401 of the prism 40F. The first magnifying side transmissive surface 411 and the second magnifying side transmissive surface 421 are regions which do not overlap with each other. This can facilitate forming the prism 40F and allow its shape to be bilaterally symmetrical. The first magnifying side transmissive surface 411 and the second magnifying side transmissive surface 421 are located on opposite sides in the length direction (the X direction) in the first surface 401 of the prism 40F.

The first reflective surface 412a of the first optical system 41F and the second reflective surface 422a of the second optical system 42F are located within the same second surface which is part of the prism 40F and faces each of the first magnifying side transmissive surface 411 and the second magnifying side transmissive surface 421. The first reflective surface 412a and the second reflective surface 422a are regions which do not overlap with each other. This can facilitate forming the prism 40F and allow its shape to be bilaterally symmetrical. The first reflective surface 412a and the second reflective surface 422a are located on opposite sides in the length direction (the ±X direction) in the second surface 402 of the prism 40F.

The third reflective surface 412b of the first optical system 41F and the fourth reflective surface 422b of the second optical system 42F are located within the same first surface which is part of the prism 40F and faces each of the first reflective surface 412a and the second reflective surface 422a. The third reflective surface 412b and the fourth reflective surface 422b are regions which do not overlap with each other. This can facilitate forming the prism 40F and allow its shape to be bilaterally symmetrical. The third reflective surface 412b and the fourth reflective surface 422b are located at a center in the length direction (the ±X direction) in the second surface 402 of the prism 40F.

The fifth reflective surface 412c of the first optical system 41F and the sixth reflective surface 422c of the second optical system 42F are located within the same first surface 401 which is part of the prism 40F and faces each of the first reflective surface 412a and the second reflective surface 422a. The fifth reflective surface 412c and the sixth reflective surface 422c are regions which do not overlap with each other. This can facilitate forming the prism 40F and allow its shape to be bilaterally symmetrical. In the present embodiment, the fifth reflective surface 412c is located between the first magnifying side transmissive surface 411 and the third reflective surface 412b and does not overlap with the first magnifying side transmissive surface 411 and the third reflective surface 412b. The sixth reflective surface 422c is located between the second magnifying side transmissive surface 421 and the fourth reflective surface 422b and does not overlap with the second magnifying side transmissive surface 421 and the fourth reflective surface 422b.

The seventh reflective surface 412d of the first optical system 41F and the eighth reflective surface 422d of the second optical system 42F are located within the same second surface 402 which is part of the prism 40F and faces each of the fifth reflective surface 412c and the sixth reflective surface 422c. The seventh reflective surface 412d and the eighth reflective surface 422d are regions which do not overlap with each other. This can facilitate forming the prism 40F and allow its shape to be bilaterally symmetrical. In the present embodiment, the seventh reflective surface 412d is located between the first reflective surface 412a and the first reducing side transmissive surface 413 and does not overlap with the first reflective surface 412a and the first reducing side transmissive surface 413. The eighth reflective surface 422d is located between the second reflective surface 422a and the second reducing side transmissive surface 423 and does not overlap with the second reflective surface 422a and the second reducing side transmissive surface 423.

### 1.7.2 Advantageous Effects

The aforementioned optical system 4F includes the first optical system 41F and the second optical system 42F which are constituted by the prism 40. The first optical system 41F defines the first optical path L1 by the first light beam group, and includes the first reducing side transmissive surface 413 facing the reducing side conjugate point F1, the first magnifying side transmissive surface 411 which is part of the prism 40F and is located farthest from the reducing side conjugate point F1 along the first optical path L1, and the first reflective surface group 412 which reflects inside the prism 40F the first light beam group with transmission of the first reducing side transmissive surface 413 and the first magnifying side transmissive surface 411 to make the reducing side conjugate point F1 and the first magnifying side conjugate point F21 be in a conjugate relation, and includes at least the first reflective surface 412a with a concave shape. The second optical system 42F defines the second optical path L2 by the second light beam group different from the first light beam group, and includes the second reducing side transmissive surface 423 facing the reducing side conjugate point F1, the second magnifying side transmissive surface 421 which is part of the prism 40F and is located farthest from the reducing side conjugate point F1 along the second optical path L2, and the second reflective surface group 422 which reflects inside the prism 40F the second light beam group with transmission of the second reducing side transmissive surface 423 and the second magnifying side transmissive surface 421 to make the reducing side conjugate point F1 and the second magnifying side conjugate point F22 be in a conjugate relation, and includes at least the second reflective surface 422a with a concave shape. The first reflective surface group 412 includes the first reducing side reflective surface (the third reflective surface 412b) which is located closest to the reducing side conjugate point F1 along the first optical path L1. The second reflective surface group 422 includes the second reducing side reflective surface (the fourth reflective surface 422b) which is located closest to the reducing side conjugate point F1 along the second optical path L2. The first reducing side reflective surface (the third reflective surface 412b) and the second reducing side reflective surface (the fourth reflective surface 422b) are located on opposite sides with regard to the straight line C1 passing through the midpoint between the first reducing side transmissive surface 413 and the second reducing side transmissive surface 423, as well as the reducing side conjugate point F1. This configuration enables reducing loss of light beam groups (the first light beam group and the second light beam group).

### 2. Variations

Embodiments of the present disclosure are not limited to the above embodiments. The above embodiments may be modified in various ways in accordance with designs or the like to an extent that they can achieve the problem of the present disclosure. Hereinafter, some variations or modifications of the above embodiments will be listed. One or more of the variations or modifications described below may apply in combination with one or more of the others.

Note that, hereinafter, if variations can be applied to any of the above embodiments 1 to 7, explanation thereof will be made with reference to reference signs used in embodiment 1. This is just for simplifying the specification or description, and there is no intent to withdraw application to embodiments 2 to 7.

In one variation, configurations of the first aperture stop 31 and the second aperture stop 32 are not limited particularly. The first aperture stop 31 and the second aperture stop 32 are not always necessary.

In one variation, the optical system 4 may include at least the first optical system 41 and the second optical system 42. In other words, the first aperture stop 431, the second aperture stop 432, the first converging optical system 441, and the second converging optical system 442 are optional.

In one variation, the first reflective surface group 412 of the first optical system 41 may include at least the first reflective surface 412a. In other words, the first reflective surface group 412 of the first optical system 41 may be constituted by only a single reflective surface. However, the first reflective surface group 412 may include two or more reflective surfaces, and this may relax restriction for arrangement of the optical system 4.

In one variation, the second reflective surface group 422 of the second optical system 42 may include at least the second reflective surface 422a. In other words, the second reflective surface group 422 of the second optical system 42 may be constituted by only a single reflective surface. However, the second reflective surface group 422 may include two or more reflective surfaces, and this may relax restriction for arrangement of the optical system 4.

In one variation, at least one of the first magnifying side transmissive surface 411, the first, third, fifth and seventh reflective surfaces 412a, 412b, 412c, 412d of the first reflective surface group 412, the first reducing side transmissive surface 413, the second magnifying side transmissive surface 421, the second, fourth, sixth and eighth reflective surfaces 422a, 422b, 422c, 422d of the second reflective surface group 422, or the second reducing side transmissive surface 423 may include a freeform surface. This configuration can improve the degree of freedom of design of the prism 40.

In one variation, configurations of the first image unit 61 and the second image unit 62 are not be limited particularly. The first image unit 61 and the second image unit 62 may be separate or discrete devices or a single device. If the first image unit 61 and the second image unit 62 are a single device, the first light beam group L11 and the second light beam L21 may be output alternately in time, or may be output simultaneously by use of a parallax barrier or the like.

In one variation, configuration of the first light guide 71 and the second light guide 72 are not limited particularly. The first light guide 71 and the second light guide 72 may not always have functionality of pupil expansion.

In one variation, the detection process of the detector 9 is not limited particularly. The detection process by the detector 9 may be performed real-time. In other words, the detector 9 may detect the positional relation between the first image and the second image even while the first light beam group L11 and the second light beam L21 are output from the first image unit 61 and the second image unit 62, respectively so that the observer 100 watches a 3D image. This enables real-time correction of positional displacement of the first image and the second image.

### 3. Aspects

As apparent from the above embodiments and variations, the present disclosure includes the following aspects. Hereinafter, reference signs in parenthesis are attached for the purpose of clearly showing correspondence with the embodiments only. Note that, in consideration of readability of texts, the reference signs in parentheses may be omitted from the second and subsequent times.

A first aspect is an optical system (4; 4C; 4D; 4E; 4F) comprising a first optical system (41; 41D; 41F) and a second optical system (42; 42D; 42F) which are constituted by a prism (40; 40D; 40F). The first optical system (41; 41D; 41F) defines a first optical path (L1) (L1) by a first light beam group (L10) and includes a first reducing side transmissive surface (413) facing a reducing side conjugate point (F1), a first magnifying side transmissive surface (411) which is part of the prism (40; 40D; 40F) and is located farthest from the reducing side conjugate point (F1) along the first optical path (L1), and a first reflective surface group (412) which reflects inside the prism (40; 40D; 40F) the first light beam group (L10) with transmission of the first reducing side transmissive surface (413) and the first magnifying side transmissive surface (411) to make the reducing side conjugate point (F1) and a first magnifying side conjugate point (F21) be in a conjugate relation, and includes at least a first reflective surface (412a) with a concave shape. The second optical system (42; 42D; 42F) defines a second optical path (L2) by a second light beam group (L20) different from the first light beam group (L10) and includes a second reducing side transmissive surface (423) facing the reducing side conjugate point (F1), a second magnifying side transmissive surface (421) which is part of the prism (40; 40D; 40F) and is located farthest from the reducing side conjugate point (F1) along the second optical path (L2), and a second reflective surface group (422) which reflects inside the prism (40; 40D; 40F) the second light beam group (L20) with transmission of the second reducing side transmissive surface (423) and the second magnifying side transmissive surface (421) to make the reducing side conjugate point (F1) and a second magnifying side conjugate point (F22) be in a conjugate relation, and includes at least a second reflective surface (422a) with a concave shape. The first reflective surface group (412) includes a first reducing side reflective surface (412a, 412b) which is located closest to the reducing side conjugate point (F1) along the first optical path (L1). The second reflective surface group (422) includes a second reducing side reflective surface (422a, 422b) which is located closest to the reducing side conjugate point (F1) along the second optical path (L2). The first reducing side reflective surface (412a, 412b) and the second reducing side reflective surface (422a, 422b) are located on opposite sides with regard to a straight line (C1) passing through a midpoint between the first reducing side transmissive surface (413) and the second reducing side transmissive surface (423), as well as the reducing side conjugate point (F1). This aspect enables reducing loss of light beam groups (the first light beam group L10 and the second light beam group L20).

A second aspect is the optical system (4; 4C; 4D; 4E; 4F) according to the first aspect. In this aspect, the first reducing side transmissive surface (413) and the second reducing side transmissive surface (423) are located within a transmissive surface facing the reducing side conjugate point (F1) and are regions which partially overlap with each other. This aspect allows decreasing a region of the prism (40; 40D; 40F) necessary for providing the first reducing side transmissive surface (413) and the second reducing side transmissive surface (423), and thus enables downsizing the prism (40; 40D; 40F).

A third aspect is the optical system (4; 4C; 4D; 4E; 4F) according to the first or second aspect. In this aspect, the first reducing side reflective surface (412a, 412b) and the second reducing side reflective surface (422a, 422b) are located within a surface (401) being part of the prism (40; 40D; 40F) and facing the first reducing side transmissive surface (413) and the second reducing side transmissive surface (423), and are regions which do not overlap with each other. This aspect can facilitate forming the prism (40; 40D; 40F) and allow its shape to be bilaterally symmetrical.

A fourth aspect is the optical system (4; 4C; 4D; 4E; 4F) according to any one of the first to third aspects. In this aspect, the first reflective surface (412a) and the second reflective surface (422a) are located within a same surface (the second surface 402) being part of the prism (40; 40D; 40F) and facing each of the first magnifying side transmissive surface (411) and the second magnifying side transmissive surface (412), and are regions which do not overlap with each other. This aspect can facilitate forming the prism (40; 40D; 40F) and allow its shape to be bilaterally symmetrical.

A fifth aspect is the optical system (4D) according to any one of the first to fourth aspects. In this aspect, the first reflective surface (412a) is the first reducing side reflective surface, and the second reflective surface (422a) is the second reducing side reflective surface. This aspect can facilitate forming the prism (40; 40D; 40F) and allow its shape to be bilaterally symmetrical.

A sixth aspect is the optical system (4; 4C; 4E; 4F) according to any one of the first to fourth aspects. In this aspect, within the first reflective surface group (412), the first reflective surface (412a) is located farthest from the first reducing side transmissive surface (413) along the first optical path (L1). Within the second reflective surface group (422), the second reflective surface (422a) is located farthest from the second reducing side transmissive surface (423) along the second optical path (L2). This aspect enables convergence or divergence of light beam groups between the first and second magnifying side conjugate points (F21, F22) and the reducing side conjugate point (F1).

A seventh aspect is the optical system (4; 4C; 4E; 4F) according to any one of the first to fourth aspects. In this aspect, the first reflective surface group (412) includes a third reflective surface (412b) which has a convex shape and is located between the first reflective surface (412a) and the first reducing side transmissive surface (413) along the first optical path (L1). The second reflective surface group (422) includes a fourth reflective surface (422b) which has a convex shape and is located between the second reflective surface (422a) and the second reducing side transmissive surface (423) along the second optical path (L2). The third reflective surface (412b) is the first reducing side reflective surface. The fourth reflective surface (422b) is the second reducing side reflective surface. This aspect enables convergence or divergence of light beam groups between the first and second magnifying side conjugate points (F21, F22) and the reducing side conjugate point (F1).

An eighth aspect is the optical system (4; 4C; 4E; 4F) according to any one of the first to seventh aspects. In this aspect, at least one of the first magnifying side transmissive surface (411), the first reflective surface group (412) (the first and third reflective surfaces 412a, 412b), the first reducing side transmissive surface (413), the second magnifying side transmissive surface (421), the second reflective surface group (422) (the second and fourth reflective surfaces 422a, 422b) or the second reducing side transmissive surface (423) includes a freeform surface. This aspect enables improvement of the degree of freedom of design of the prism (40; 40D; 40F).

A ninth aspect is a display device (1; 1A; 1B) comprising: the optical system according to any one of the first to eighth aspects; and a display unit (2; 2A) including a display element (21) located at the reducing side conjugate point (F1). The display element (21) is configured to output a first light beam group (L10) forming a first image (P1) toward the first reducing side transmissive surface (413) and output a second light beam group (L20) forming a second image (P2) toward the second reducing side transmissive surface (423). The first optical system (41; 41D; 41F) forms the first image (P1) by the first light beam group (L10) at the first magnifying side conjugate point (F21). The second optical system (42; 42D; 42F) forms the second image (P2) by the second light beam group (L20) at the second magnifying side conjugate point (F22). This aspect enables display of two images by the single display element (21).

A tenth aspect is the display device (1; 1A; 1B) according to the ninth aspect. In this aspect, the first image (P1) and the second image (P2) are different from each other. This aspect enables display of a 3D image.

An eleventh aspect is the display device (1; 1B) according to the tenth aspect. In this aspect, the display element (21) is configured to output the first light beam group (L10) and the second light beam group (L20) simultaneously. The display unit (2) includes a parallax barrier (22) located between the optical system (4; 4C; 4D; 4E; 4F) and the display element (21). The parallax barrier (22) allows only the first light beam group (L10) of the first light beam group (L10) and the second light beam group (L20) to be incident on the first reducing side transmissive surface (413) and allows only the second light beam group (L20) of the first light beam group (L10) and the second light beam group (L20) to be incident on the second reducing side transmissive surface (423). This aspect enables display of two images by the single display element (21).

A twelfth aspect is the display device (1A) according to the tenth aspect. In this aspect, the display device (1A) further comprising: a first aperture stop (31) configured to open and close and located on an optical path of the first light beam group (L10); and a second aperture stop (32) configured to open and close and located on an optical path of the second light beam group (L20). The display unit (2A) is configured to control the first aperture stop (31) and the second aperture stop (32) and the display element (21) in such a manner that the first light beam group (L10) is output while the first aperture stop (31) is open and the second aperture stop (32) is closed and the second light beam group (L20) is output while the first aperture stop (31) is closed and the second aperture stop (32) is open. This aspect enables display of two images by the single display element (21).

A thirteenth aspect is the display device (1; 1A; 1B) according to any one of the tenth to twelfth aspects. In this aspect, the first reducing side transmissive surface (413) and the second reducing side transmissive surface (423) are located within a transmissive surface facing the reducing side conjugate point (F1) and are regions which partially overlap with each other. This aspect can facilitate forming the prism (40; 40D; 40F) and allow its shape to be bilaterally symmetrical.

A fourteenth aspect is the display device (1; 1A; 1B) according to any one of the ninth to thirteenth aspects. In this aspect, a direction in which the first light beam group (L10) emerges from the first magnifying side transmissive surface (411) and a direction in which the second light beam group (L20) emerges from the second magnifying side transmissive surface (421) are different from each other. This aspect allows application to configuration where light beam groups emerge in left and right directions.

A fifteenth aspect is the display device (1; 1B) according to the fourteenth aspect. In this aspect, the first optical system (41; 41D; 41F) and the second optical system (42; 42D; 42F) are line-symmetric with regard to the straight line (C1). This aspect allows application to configuration where light beam groups emerge in left and right directions.

A sixteenth aspect is an imaging device (11C) comprising: the optical system (4; 4C; 4D; 4E; 4F) according to any one of the first to eighth aspects; and an imaging element (8) located at the reducing side conjugate point (F1). The optical system (4; 4C; 4D; 4E; 4F) is located to allow a first light beam group (L10) forming a first image to be incident on the first magnifying side transmissive surface (411) from the first magnifying side conjugate point (F21), and to allow a second light beam group (L20) forming a second image to be incident on the second magnifying side transmissive surface (421) from the second magnifying side conjugate point (F22). The first optical system (41; 41D; 41F) forms the first image by the first light beam group (L10) at the imaging element (8). The second optical system (42; 42D; 42F) forms the second image by the second light beam group (L20) at the imaging element (8). This aspect enables reducing loss of light beam groups. Additionally, this aspect allows a single imaging element to capture two images.

A seventeenth aspect is the imaging device (11C) according to the sixteenth aspect. In this aspect, a direction in which the first light beam group (L10) is incident on the first magnifying side transmissive surface (411) and a direction in which the second light beam group (L20) is incident on the second magnifying side transmissive surface (421) are different from each other. This aspect allows application to configuration where light beam groups are incident in left and right directions.

An eighteenth aspect is the imaging device (11C) according to the seventeenth aspect. In this aspect, the first optical system (41; 41D; 41F) and the second optical system (42; 42D; 42F) are line-symmetric with regard to the straight line (C1). This aspect allows application to configuration where light beam groups are incident in left and right directions.

The second to eighth, tenth to fifteenth, seventeenth, and eighteenth aspects are optional and are not necessary.

### INDUSTRIAL APPLICABILITY

The present disclosure is applicable to optical systems, display devices, and imaging devices. In more detail, the present disclosure is applicable to an optical system including a first optical system and a second optical system which define different optical paths, a display device including the optical system, and an imaging device including the optical system.

### REFERENCE SIGNS LIST

1, 1A, 1B Display Device
10C Image Projection Device
11C Imaging Device
2, 2A Display Unit
21 Display Element
22 Parallax Barrier
31, 431 First Aperture Stop
32, 432 Second Aperture Stop
4, 4C, 4D, 4E, 4F Optical System
40, 40D, 40F Prism
401 First Surface
402 Second Surface
41, 41D, 41F First Optical System
411 First Magnifying Side Transmissive Surface
412 First Reflective Surface Group
412a First Reflective Surface
412b Third Reflective Surface
412c Fifth Reflective Surface
412d Seventh Reflective Surface
413 First Reducing Side Transmissive Surface
42, 42D, 42F Second Optical System
421 Second Magnifying Side Transmissive Surface
422 Second Reflective Surface Group
422a Second Reflective Surface
422b Fourth Reflective Surface
422c Sixth Reflective Surface
422d Eighth Reflective Surface
423 Second Reducing Side Transmissive Surface
441 First Convergence Optical System
442 Second Convergence Optical System
8 Imaging Element
F1 Reducing Side Conjugate Point
F21, F21a First Magnifying Side Conjugate Point
F22, F22a Second Magnifying Side Conjugate Point
L1 First Optical Path
L10, L11 First Light Beam Group
L2 Second Optical Path
L20, L21 Second Light Beam Group
P1 First Image
P2 Second Image
C1 Straight Line (straight line passing through the midpoint between the first and second reducing side transmissive surfaces and the reducing side conjugate point)

1. An optical system comprising a first optical system and a second optical system which are constituted by a prism,
the first optical system defining a first optical path by a first light beam group and including
a first reducing side transmissive surface facing a reducing side conjugate point,
a first magnifying side transmissive surface which is part of the prism and is located farthest from the reducing side conjugate point along the first optical path, and
a first reflective surface group which reflects inside the prism the first light beam group with transmission of the first reducing side transmissive surface and the first magnifying side transmissive surface to make the reducing side conjugate point and a first magnifying side conjugate point be in a conjugate relation, and includes at least a first reflective surface with a concave shape,
the second optical system defining a second optical path by a second light beam group different from the first light beam group and including
a second reducing side transmissive surface facing the reducing side conjugate point,
a second magnifying side transmissive surface which is part of the prism and is located farthest from the reducing side conjugate point along the second optical path, and
a second reflective surface group which reflects inside the prism the second light beam group with transmission of the second reducing side transmissive surface and the second magnifying side transmissive surface to make the reducing side conjugate point and a second magnifying side conjugate point be in a conjugate relation, and includes at least a second reflective surface with a concave shape,
the first reflective surface group including a first reducing side reflective surface which is located closest to the reducing side conjugate point along the first optical path,
the second reflective surface group including a second reducing side reflective surface which is located closest to the reducing side conjugate point along the second optical path, and
the first reducing side reflective surface and the second reducing side reflective surface being located on opposite sides with regard to a straight line passing through a midpoint between the first reducing side transmissive surface and the second reducing side transmissive surface, as well as the reducing side conjugate point.

2. The optical system according to claim 1, wherein the first reducing side transmissive surface and the second reducing side transmissive surface are located within a transmissive surface facing the reducing side conjugate point and are regions which partially overlap with each other.

3. The optical system according to claim 1, wherein the first reducing side reflective surface and the second reducing side reflective surface are located within a surface being part of the prism and facing the first reducing side transmissive surface and the second reducing side transmissive surface, and are regions which do not overlap with each other.

4. The optical system according to claim 1, wherein the first reflective surface and the second reflective surface are located within a same surface being part of the prism and facing each of the first magnifying side transmissive surface and the second magnifying side transmissive surface, and are regions which do not overlap with each other.

5. The optical system according to claim 1, wherein:
the first reflective surface is the first reducing side reflective surface; and
the second reflective surface is the second reducing side reflective surface.

6. The optical system according to claim 1, wherein:
within the first reflective surface group, the first reflective surface is located farthest from the first reducing side transmissive surface along the first optical path; and
within the second reflective surface group, the second reflective surface is located farthest from the second reducing side transmissive surface along the second optical path.

7. The optical system according to claim 1, wherein:
the first reflective surface group includes a third reflective surface which has a convex shape and is located between the first reflective surface and the first reducing side transmissive surface along the first optical path;
the second reflective surface group includes a fourth reflective surface which has a convex shape and is located between the second reflective surface and the second reducing side transmissive surface along the second optical path;
the third reflective surface is the first reducing side reflective surface; and
the fourth reflective surface is the second reducing side reflective surface.

8. The optical system according to claim 1, wherein at least one of the first magnifying side transmissive surface, the first reflective surface group, the first reducing side transmissive surface, the second magnifying side transmissive surface, the second reflective surface group or the second reducing side transmissive surface includes a freeform surface.

9. A display device comprising:
the optical system according to claim 1; and
a display unit including a display element located at the reducing side conjugate point,
wherein:
the display element is configured to output a first light beam group forming a first image toward the first reducing side transmissive surface and output a second light beam group forming a second image toward the second reducing side transmissive surface;
the first optical system forms the first image by the first light beam group at the first magnifying side conjugate point; and
the second optical system forms the second image by the second light beam group at the second magnifying side conjugate point.

10. The display device according to claim 9, wherein the first image and the second image are different from each other.

11. The display device according to claim 10, wherein:
the display element is configured to output the first light beam group and the second light beam group simultaneously;
the display unit includes a parallax barrier located between the optical system and the display element; and
the parallax barrier allows only the first light beam group of the first light beam group and the second light beam group to be incident on the first reducing side transmissive surface and allows only the second light beam group of the first light beam group and the second light beam group to be incident on the second reducing side transmissive surface.

12. The display device according to claim 10, further comprising:
a first aperture stop configured to open and close, the first aperture stop being located on an optical path of the first light beam group; and
a second aperture stop configured to open and close, the second aperture stop being located on an optical path of the second light beam group,
wherein the display unit is configured to control the first aperture stop and the second aperture stop and the display element in such a manner that the first light beam group is output while the first aperture stop is open and the second aperture stop is closed and the second light beam group is output while the first aperture stop is closed and the second aperture stop is open.

13. The display device according to claim 9, wherein the first reducing side transmissive surface and the second reducing side transmissive surface are located within a transmissive surface facing the reducing side conjugate point and are regions which partially overlap with each other.

14. The display device according to claim 9, wherein a direction in which the first light beam group emerges from the first magnifying side transmissive surface and a direction in which the second light beam group emerges from the second magnifying side transmissive surface are different from each other.

15. The display device according to claim 14, wherein the first optical system and the second optical system are line-symmetric with regard to the straight line.

16. An imaging device comprising:
the optical system according to claim 1; and
an imaging element located at the reducing side conjugate point,
wherein:
the optical system is located to allow a first light beam group forming a first image to be incident on the first magnifying side transmissive surface from the first magnifying side conjugate point, and to allow a second light beam group forming a second image to be incident on the second magnifying side transmissive surface from the second magnifying side conjugate point;
the first optical system forms the first image by the first light beam group at the imaging element; and
the second optical system forms the second image by the second light beam group at the imaging element.

17. The imaging device according to claim 16, wherein a direction in which the first light beam group is incident on the first magnifying side transmissive surface and a direction in which the second light beam group is incident on the second magnifying side transmissive surface are different from each other.

18. The imaging device according to claim 17, wherein the first optical system and the second optical system are line-symmetric with regard to the straight line.
